(19) United States
(12) Patent Application Publication
(10) Pub. No.: US 2025/0303842 A1
(43) Pub. Date: Oct. 2, 2025

(54) VEHICLE CONTROL METHOD AND VEHICLE CONTROL DEVICE

(71) Applicant: PANASONIC AUTOMOTIVE SYSTEMS CO., LTD., Kanagawa (JP)

(72) Inventors: Atsushi SUEYOSHI, Tokyo (JP); Katsuji TANIGUCHI, Kanagawa (JP); Yuya TANAKA, Kanagawa (JP)

(73) Assignee: PANASONIC AUTOMOTIVE SYSTEMS CO., LTD., Kanagawa (JP)

(21) Appl. No.: 19/040,355

(22) Filed: Jan. 29, 2025

(30) Foreign Application Priority Data
Mar. 27, 2024 (JP) 2024-052246
Mar. 27, 2024 (JP) 2024-052247
Aug. 7, 2024 (JP) 2024-131186
Aug. 7, 2024 (JP) 2024-131187

(51) Int. Cl. B60K 1/04; B60L 50/64; B60L 58/26; H01M 10/613; H01M 10/625; H01M 10/63; H01M 10/6554; H01M 10/6568; H01M 50/204; H01M 50/249

(52) U.S. Cl. CPC B60K 1/04; B60L 50/64; B60L 58/26; H01M 10/613; H01M 10/625; H01M 10/63; H01M 10/6554; H01M 10/6568; H01M 50/204; H01M 50/249; B60K 2001/0438; H01M 2220/20

(57) ABSTRACT

A vehicle includes a first heat exchange plate having a first refrigerant layer and a first coolant layer, and a second heat exchange plate having a second refrigerant layer and a second coolant layer. The first and second exchange plates are respectively capable of exchanging heat with first and second battery packs. When a first temperature of the first battery pack and the second battery pack is lower than a first threshold temperature, a vehicle control device causes a refrigerant to circulate through the first refrigerant layer at a first flow rate, and causes the refrigerant to circulate through the second refrigerant layer at a second flow rate. When a third temperature of the first battery pack is higher than a second threshold temperature, the vehicle control device charges the first battery pack and causes the coolant to circulate through the first and second coolant layers in this order.

### TECHNICAL FIELD

The present disclosure relates to a vehicle control method and a vehicle control device.

### BACKGROUND ART

For example, it is known that charging efficiency of a secondary battery decreases in a low-temperature environment. Patent Literature 1 discloses that a vehicle includes an external flow path, a PTC heater, four internal flow paths and four temperature sensors corresponding to four batteries, external and internal control valves, and a control device that charges the four batteries while shifting charging start timings, the control device supplies hot water heated by the PTC heater to the internal flow path of the battery having a temperature lower than a first temperature, supplies hot water heated by heat exchange with the battery being charged to the internal flow path of the battery not yet being charged when there are the battery being charged that is at or above a second temperature and the battery not yet being charged that is below the first temperature, and supplies the hot water heated by the heat exchange with the battery being charged to the external flow path when there is no battery not yet being charged.

### CITATION LIST

### Patent Literature

Patent Literature 1: JP2023-101151A

### SUMMARY OF INVENTION

However, in Patent Literature 1, since temperatures of the four batteries are adjusted using only the hot water, variations in temperature tend to occur among the batteries, making it difficult to heat the batteries substantially uniformly.

An object of the present disclosure is to provide a technique for substantially uniformly heating a chargeable and dischargeable battery mounted on a vehicle.

A vehicle control method executable in a vehicle is provided.

The vehicle includes
a vehicle body,
   a first wheel and a second wheel coupled to the vehicle body,
   a first battery pack disposed along a first surface in the vehicle body,
   a second battery pack disposed along a second surface in the vehicle body,
   a first heat exchange plate disposed along the first surface in the vehicle body,
   a second heat exchange plate disposed along the second surface in the vehicle body, and
   an electric motor that drives at least the first wheel using electric power supplied from the first battery pack and/or the second battery pack,
the vehicle is movable by the first wheel and the second wheel in a predetermined direction,
the first heat exchange plate includes
   a third surface disposed along the first surface and capable of exchanging heat with the first battery pack,
   a fourth surface disposed along the first surface and opposite to the third surface,
   a first refrigerant layer in which a refrigerant circulates between the third surface and the fourth surface, and
   a first coolant layer in which a coolant circulates between the third surface and the fourth surface,
the second heat exchange plate includes
   a fifth surface disposed along the second surface and capable of exchanging heat with the second battery pack,
   a sixth surface disposed along the second surface and opposite to the fifth surface,
   a second refrigerant layer in which the refrigerant circulates between the fifth surface and the sixth surface, and
   a second coolant layer in which the coolant circulates between the fifth surface and the sixth surface.

The vehicle control method includes
in a case that a first temperature of the first battery pack and the second battery pack is lower than a first threshold temperature, causing the refrigerant to circulate through the first refrigerant layer of the first heat exchange plate at a first flow rate, and causing the refrigerant to circulate through the second refrigerant layer of the second heat exchange plate at a second flow rate lower than the first flow rate, a second temperature of the refrigerant entering the first refrigerant layer being higher than the first temperature of the first battery pack; and
in a case that a third temperature of the first battery pack is higher than a second threshold temperature higher than the first threshold temperature, charging the first battery pack and causing the coolant to circulate through the first coolant layer and the second coolant layer in this order.

A vehicle control device set to be mounted in a vehicle is provided.

The vehicle includes
a vehicle body,
a first wheel and a second wheel coupled to the vehicle body,
a first battery pack disposed along a first surface in the vehicle body,
a second battery pack disposed along a second surface in the vehicle body,
a first heat exchange plate disposed along the first surface in the vehicle body,
a second heat exchange plate disposed along the second surface in the vehicle body, and
an electric motor that drives at least the first wheel using electric power supplied from the first battery pack and/or the second battery pack,
the vehicle is movable by the first wheel and the second wheel in a predetermined direction,
the first heat exchange plate includes
   a third surface disposed along the first surface and capable of exchanging heat with the first battery pack,
   a fourth surface disposed along the first surface and opposite to the third surface,
   a first refrigerant layer in which a refrigerant circulates between the third surface and the fourth surface, and
   a first coolant layer in which a coolant circulates between the third surface and the fourth surface,
the second heat exchange plate includes
   a fifth surface disposed along the second surface and capable of exchanging heat with the second battery pack,
   a sixth surface disposed along the second surface and opposite to the fifth surface,
   a second refrigerant layer in which the refrigerant circulates between the fifth surface and the sixth surface, and
   a second coolant layer in which the coolant circulates between the fifth surface and the sixth surface.

In a case that a first temperature of the first battery pack and the second battery pack is lower than a first threshold temperature, the refrigerant is circulated through the first refrigerant layer of the first heat exchange plate at a first flow rate, and is circulated through the second refrigerant layer of the second heat exchange plate at a second flow rate lower than the first flow rate, and a second temperature of the refrigerant entering the first refrigerant layer is higher than the first temperature of the first battery pack, and then
in a case that a third temperature of the first battery pack is higher than a second threshold temperature higher than the first threshold temperature, the first battery pack is charged, and the coolant is circulated through the first coolant layer and the second coolant layer in this order.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, a chargeable and dischargeable battery mounted on a vehicle can be heated substantially uniformly.

### BRIEF DESCRIPTION OF DRAWINGS

FIG. 1 is a plan view illustrating a configuration example of a vehicle according to a first embodiment;

FIG. 2 is a left side view showing the configuration example of the vehicle according to the first embodiment;

FIG. 3 is a diagram illustrating an example of an electric circuit provided in the vehicle according to the first embodiment;

FIG. 4A is a plan view showing an arrangement example of a first heat exchange plate and first battery packs according to the first embodiment, and FIG. 4B is a plan view showing an arrangement example of a second heat exchange plate and second battery packs according to the first embodiment;

FIG. 5A is a cross-sectional view showing the arrangement example of the first heat exchange plate and the first battery packs according to the first embodiment, and FIG. 5B is a cross-sectional view showing the arrangement example of the second heat exchange plate and the second battery packs according to the first embodiment;

FIG. 6 is a plan view showing a configuration example of a first refrigerant layer according to the first embodiment;

FIG. 7 is a plan view showing a configuration example of a first coolant layer according to the first embodiment;

FIG. 8 is a schematic diagram showing an example of a refrigerant circuit and a coolant circuit in a first heating mode according to the first embodiment;

FIG. 9 is a schematic diagram showing an example of a refrigerant circuit and a coolant circuit in a second heating mode according to the first embodiment;

FIG. 10 is a schematic diagram showing an example of a refrigerant circuit and a coolant circuit in a cooling mode according to the first embodiment;

FIG. 11 is a schematic diagram showing an example of a refrigerant circuit and a coolant circuit in a first heating mode according to a second embodiment;

FIG. 12 is a schematic diagram showing an example of a refrigerant circuit and a coolant circuit in a second heating mode according to the second embodiment;

FIG. 13 is a schematic diagram showing an example of a refrigerant circuit and a coolant circuit in a cooling mode according to the second embodiment;

FIG. 14 is a schematic diagram showing a configuration of a heat exchange plate and an arrangement example of battery packs according to a third embodiment;

FIG. 15 is a schematic diagram showing a cross section taken along a line A-A of the heat exchange plate shown in FIG. 14;

FIG. 16 is a schematic diagram showing an example of a refrigerant circuit and coolant circuits in a first heating mode according to the third embodiment;

FIG. 17 is a schematic diagram showing an example of a refrigerant circuit and coolant circuits in a second heating mode according to the third embodiment;

FIG. 18 is a schematic diagram showing an example of a refrigerant circuit and a coolant circuit in a cooling mode according to the third embodiment;

FIG. 19 is a schematic diagram showing a configuration of a heat exchange plate and an arrangement example of battery packs according to a fourth embodiment;

FIG. 20 is a schematic diagram showing an example of a refrigerant circuit and a coolant circuit in a first heating mode according to the fourth embodiment;

FIG. 21 is a schematic diagram showing an example of a refrigerant circuit and a coolant circuit in a second heating mode according to the fourth embodiment; and

FIG. 22 is a schematic diagram showing an example of a refrigerant circuit and a coolant circuit in a cooling mode according to the fourth embodiment.

### DESCRIPTION OF EMBODIMENTS

Hereinafter, embodiments of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, and are not intended to limit the subject matter described in claims.

### (First Embodiment) <Configuration of Vehicle>

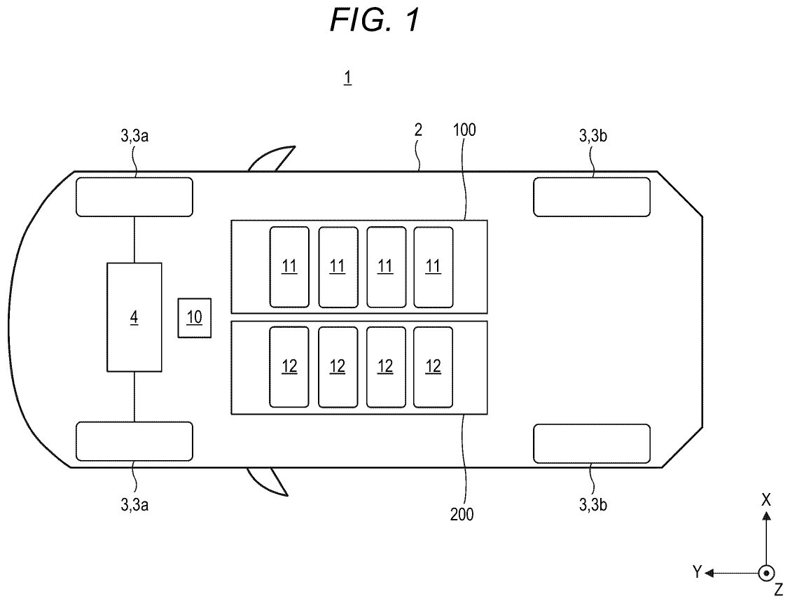

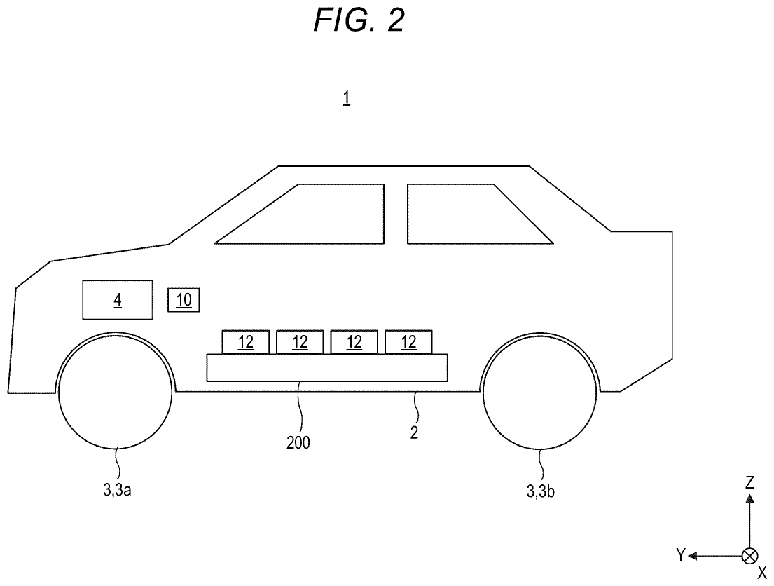

FIG. 1 is a plan view showing a configuration example of a vehicle 1 according to a first embodiment. FIG. 2 is a left side view showing the configuration example of the vehicle 1 according to the first embodiment.

For convenience of description, as shown in FIGS. 1 and 2, an axis extending in a height direction of the vehicle 1 is taken as a Z axis. An axis perpendicular to the Z axis (that is, parallel to ground) and extending in a traveling direction of the vehicle 1 is taken as a Y axis. An axis perpendicular to the Y axis and the Z axis (that is, an axis in a width direction of the vehicle 1) is taken as an X axis. For convenience of description, a positive direction of the Z axis may be referred to as “upper”, a negative direction of the Z axis may be referred to as “lower”, a positive direction of the Y axis may be referred to as “front”, a negative direction of the Y axis may be referred to as “rear”, a positive direction of the X axis may be referred to as “right”, and a negative direction of the X axis may be referred to as “left”. These expressions are the same for other drawings describing the XYZ axes. The expressions related to these directions are used for convenience of explanation, and are not intended to limit a posture of the structure in actual use.

As shown in FIGS. 1 and 2, the vehicle 1 includes a vehicle body 2, wheels 3, an electric motor 4, a control device 10, a first heat exchange plate 100, a second heat exchange plate 200, first battery packs 11, and second battery packs 12. The control device 10 may be read as a vehicle control device.

The wheels 3 are coupled to the vehicle body 2. Although FIGS. 1 and 2 show an automobile in which the vehicle 1 includes four wheels 3, the vehicle 1 may include at least one wheel 3. For example, the vehicle 1 may be a motorcycle (bike) including two wheels 3 or a vehicle including three or five or more wheels 3. Further, one of the plurality of wheels 3 provided in the vehicle 1 may be referred to as a first wheel 3a, and one of the plurality of wheels 3, which is different from the first wheel 3a, may be referred to as a second wheel 3b. The first wheel 3a may be a front wheel of the vehicle 1, and the second wheel 3b may be a rear wheel of the vehicle 1. The vehicle 1 is movable in a predetermined direction (for example, a front-rear direction of the vehicle 1) by the first wheel 3a and the second wheel 3b.

The electric motor 4 drives at least one wheel 3 (for example, the first wheel 3a) using electric power supplied from a secondary battery. The vehicle 1 includes at least one electric motor 4. The vehicle 1 may have a configuration in which the electric motor 4 drives the front wheel (that is, a front wheel drive configuration). Alternatively, the vehicle 1 may have a configuration in which the electric motor 4 drives the rear wheel (that is, a rear wheel drive configuration) or a configuration in which the electric motor 4 drives both the front wheel and the rear wheel (that is, a four wheel drive configuration). Alternatively, the vehicle 1 may include a plurality of electric motors 4, and each of the plurality of electric motors 4 may individually drive the wheel 3. The electric motor 4 may be installed in a motor room (engine room) located in front of the vehicle 1.

The control device 10 performs various controls of the vehicle 1. The control device 10 may be read as a vehicle control device, an electronic control unit (ECU), a processor, a controller, or the like.

The first heat exchange plate 100 and the first battery packs 11, and the second heat exchange plate 200 and the second battery packs 12 are accommodated in the vehicle body 2.

The first heat exchange plate 100 and the second heat exchange plate 200 may be disposed along a predetermined direction (for example, the front-rear direction of the vehicle 1). The first heat exchange plate 100 and the second heat exchange plate 200 may be disposed along a direction orthogonal to the predetermined direction (for example, the front-rear direction of the vehicle 1), and the orthogonal direction may be a horizontal direction (for example, the width direction of the vehicle 1).

Each of the first battery pack 11 and the second battery pack 12 includes one or more rechargeable secondary batteries. An example of the secondary battery is a lithium ion battery. The secondary battery supplies (discharges) stored electric power to the electric motor 4 or the like. The secondary battery may store (charge) electric power generated by the electric motor 4 by regenerative energy. As shown in FIGS. 1 and 2, the first heat exchange plate 100 and the first battery packs 11, and the second heat exchange plate 200 and the second battery packs 12 may be accommodated under a floor at a center of the vehicle body 2. Details of the configurations of the first heat exchange plate 100 and the second heat exchange plate 200 will be described later.

### <Configuration of Electric Circuit>

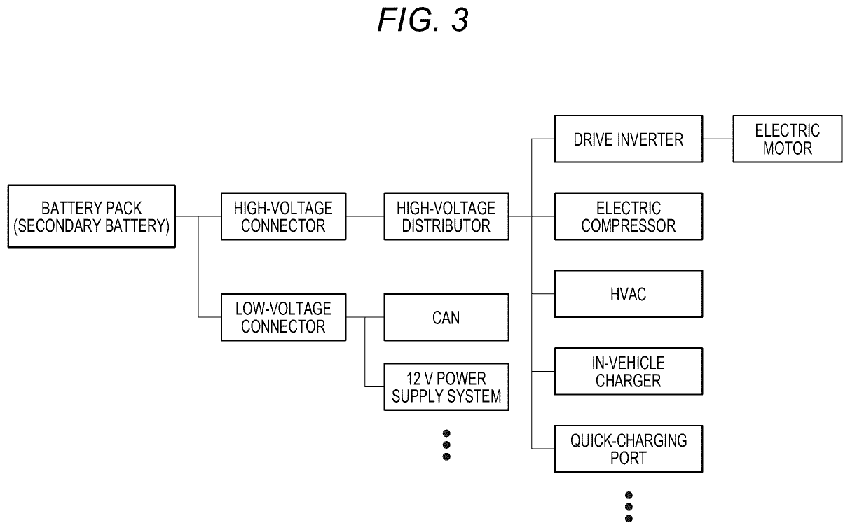

FIG. 3 is a diagram showing an example of an electric circuit provided in the vehicle 1 according to the first embodiment.

The first battery pack 11 and the second battery pack 12 each including a secondary battery have a high-voltage connector and a low-voltage connector. In the present disclosure, the high-voltage connector and the low-voltage connector are referred to as electrical connectors without being distinguished from each other.

A high-voltage distributor may be connected to the high-voltage connector. The high-voltage distributor may be connected to a drive inverter, an electric compressor, a heating, ventilation, and air conditioning (HVAC), an in-vehicle charger, and a quick-charging port. The low-voltage connector may be connected to a controller area network (CAN) and a 12 V power supply system.

The electric motor 4 may be connected to the drive inverter. That is, the electric power output from the secondary battery may be supplied to the electric motor 4 through the high-voltage connector, the high-voltage distributor, and the drive inverter.

### <Configurations of First Heat Exchange Plate and Second Heat Exchange Plate>

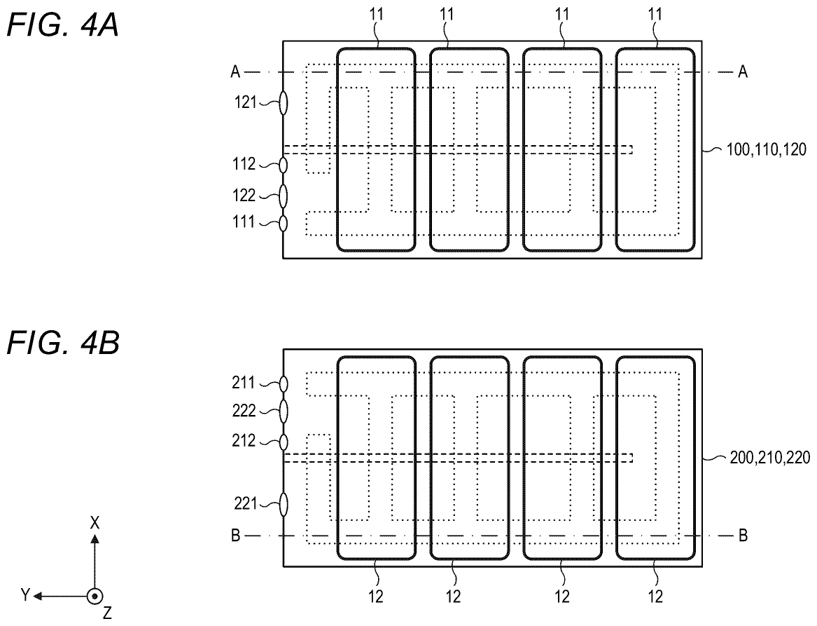

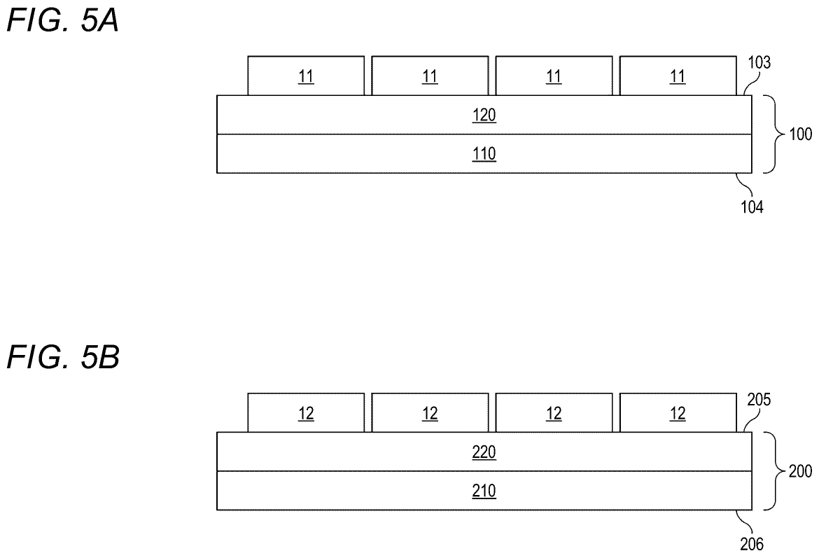

FIG. 4A is a plan view showing an arrangement example of the first heat exchange plate 100 and the first battery packs 11 according to the first embodiment. FIG. 4B is a plan view showing an arrangement example of the second heat exchange plate 200 and the second battery packs 12 according to the first embodiment. FIG. 5A is a cross-sectional view showing an arrangement example of the first heat exchange plate 100 and the first battery packs 11 according to the first embodiment. FIG. 5B is a cross-sectional view showing an arrangement example of the second heat exchange plate 200 and the second battery packs 12 according to the first embodiment. FIG. 5A shows a cross-sectional view taken along a line A-A in FIG. 4A, and FIG. 5B shows a cross-sectional view taken along a line B-B in FIG. 4B.

The first heat exchange plate 100 and the second heat exchange plate 200 may have a flat, substantially rectangular parallelepiped shape. The first heat exchange plate 100 and the second heat exchange plate 200 may be read as heat exchangers.

The first battery packs 11 are disposed along a first surface. The first heat exchange plate 100 is disposed along the first surface. The first surface may be a floor surface of the vehicle body 2. The second battery packs 12 are disposed along a second surface. The second heat exchange plate 200 is disposed along the second surface. The second surface may be a floor surface of the vehicle body 2.

As shown in FIG. 5A, the first heat exchange plate 100 includes a third surface 103 disposed along the first surface and capable of exchanging heat with the first battery packs 11, and a fourth surface 104 disposed along the first surface and opposite to the third surface 103. Members of the third surface 103 and the fourth surface 104 may be made of metal, for example, aluminum. However, the third surface 103 and the fourth surface 104 are not limited to metal and may be made of other materials.

As shown in FIG. 5A, the first heat exchange plate 100 includes a first refrigerant layer 110 in which a refrigerant circulates between the third surface 103 and the fourth surface 104, and a first coolant layer 120 in which a coolant circulates between the third surface 103 and the fourth surface 104. Examples of the refrigerant include hydrofluorocarbon (HFC). Examples of the coolant include an antifreezing solution containing ethylene glycol.

As shown in FIG. 5A, in the present embodiment, the first coolant layer 120 is disposed on the first refrigerant layer 110, and the first battery packs 11 are disposed on the first coolant layer 120. However, the first refrigerant layer 110 may be disposed on the first coolant layer 120, and the first battery packs 11 may be disposed on the first refrigerant layer 110.

As shown in FIG. 4A, the first heat exchange plate 100 includes a first refrigerant input portion 111 that allows the refrigerant to enter the first refrigerant layer 110, and a first refrigerant output portion 112 that allows the refrigerant to exit from the first refrigerant layer 110.

As shown in FIG. 4A, the first heat exchange plate 100 includes a first coolant input portion 121 through which the coolant enters the first coolant layer 120, and a first coolant output portion 122 through which the coolant exits from the first coolant layer 120.

As shown in FIG. 5B, the second heat exchange plate 200 includes a fifth surface 205 disposed along the second surface and capable of exchanging heat with the second battery packs 12, and a sixth surface 206 disposed along the second surface and opposite to the fifth surface 205. Members of the fifth surface 205 and the sixth surface 206 may be made of metal, for example, aluminum. However, the fifth surface 205 and the sixth surface 206 are not limited to metal and may be made of other materials.

As shown in FIG. 5B, the second heat exchange plate 200 includes a second refrigerant layer 210 in which the refrigerant circulates between the fifth surface 205 and the sixth surface 206, and a second coolant layer 220 in which the coolant circulates between the fifth surface 205 and the sixth surface 206.

As shown in FIG. 5B, in the present embodiment, the second coolant layer 220 is disposed on the second refrigerant layer 210, and the second battery packs 12 are disposed on the second coolant layer 220. However, the second refrigerant layer 210 may be disposed on the second coolant layer 220, and the second battery packs 12 may be disposed on the second refrigerant layer 210.

As shown in FIG. 4B, the second heat exchange plate 200 includes a second refrigerant input portion 211 that allows the refrigerant to enter the second refrigerant layer 210, and a second refrigerant output portion 212 that allows the refrigerant to exit from the second refrigerant layer 210.

As shown in FIG. 4B, the second heat exchange plate 200 includes a second coolant input portion 221 that allows the coolant to enter the second coolant layer 220, and a second coolant output portion 222 that allows the coolant to exit from the second coolant layer 220.

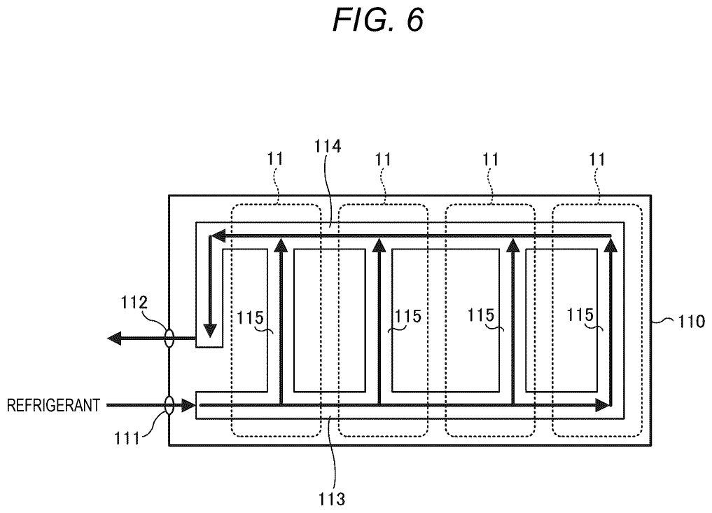

FIG. 6 is a plan view showing a configuration example of the first refrigerant layer 110 according to the first embodiment. The second refrigerant layer 210 may have the same configuration.

As shown in FIG. 6, the first refrigerant layer 110 includes a first refrigerant passage 113 extending in a predetermined direction (for example, a Y direction), a second refrigerant passage 114 disposed along the first refrigerant passage (for example, parallel to the first refrigerant passage), and a plurality of branch refrigerant passages 115 connecting the first refrigerant passage 113 and the second refrigerant passage 114. The refrigerant that has entered the first refrigerant input portion 111 moves through the first refrigerant passage 113, moves to the second refrigerant passage 114 via the plurality of branch refrigerant passages 115, and exits from the first refrigerant output portion 112. In the present embodiment, the first refrigerant passage 113, the second refrigerant passage 114, and the branch refrigerant passages 115 may be collectively referred to as refrigerant passages.

The first battery packs 11 may be disposed on the branch refrigerant passages 115 in a plan view. Accordingly, the refrigerant moving through the branch refrigerant passages 115 of the first refrigerant layer 110 can efficiently exchange heat with the first battery pack 11 via the coolant moving through the first coolant layer 120.

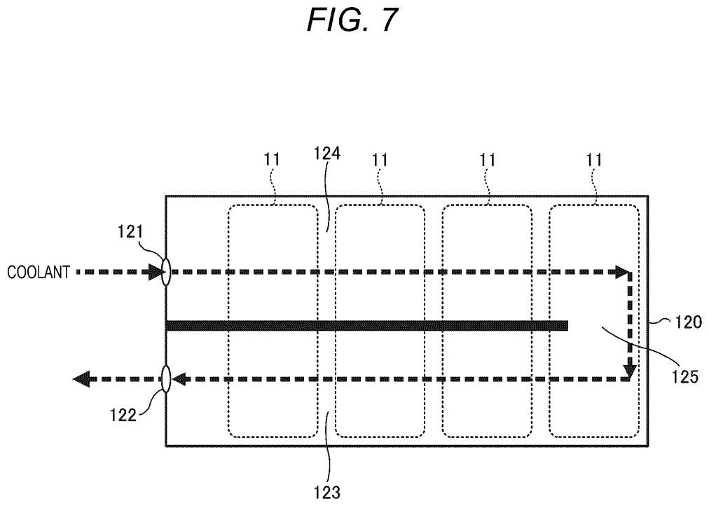

FIG. 7 is a plan view showing a configuration example of the first coolant layer 120 according to the first embodiment. The second coolant layer 220 may have the same configuration.

As shown in FIG. 7, the first coolant layer 120 includes a first coolant passage 123 extending in the predetermined direction (for example, the Y direction), a second coolant passage 124 disposed along the first coolant passage 123 (for example, parallel to the first coolant passage 123), and a third coolant passage 125 connecting the first coolant passage 123 and the second coolant passage 124. The coolant that has entered from the first coolant input portion 121 moves through the first coolant passage 123, the third coolant passage 125, and the second coolant passage 124 in this order, and exits from the first coolant output portion 122. In the present embodiment, the first coolant passage 123, the third coolant passage 125, and the second coolant passage 124 may be collectively referred to as coolant passages.

Heat exchange is performed between the refrigerant moving through the refrigerant passages of the first refrigerant layer 110 and the coolant moving through the coolant passages of the first coolant layer 120, and a temperature of the third surface 103 is made substantially uniform. Accordingly, a temperature of the first battery packs 11 capable of exchanging heat with the third surface 103 can be adjusted substantially uniformly. Temperature adjustment includes both heating and cooling, and means that the temperature is adjusted to an appropriate temperature. Similarly, the heat exchange is performed between the refrigerant moving through the refrigerant passages of the second refrigerant layer 210 and the coolant moving through the coolant passages of the second coolant layer 220, and a temperature of the fifth surface 205 is made substantially uniform. Accordingly, a temperature of the second battery packs 12 which is capable of exchanging heat with the fifth surface 205 can be adjusted substantially uniformly.

### <First Heating Mode>

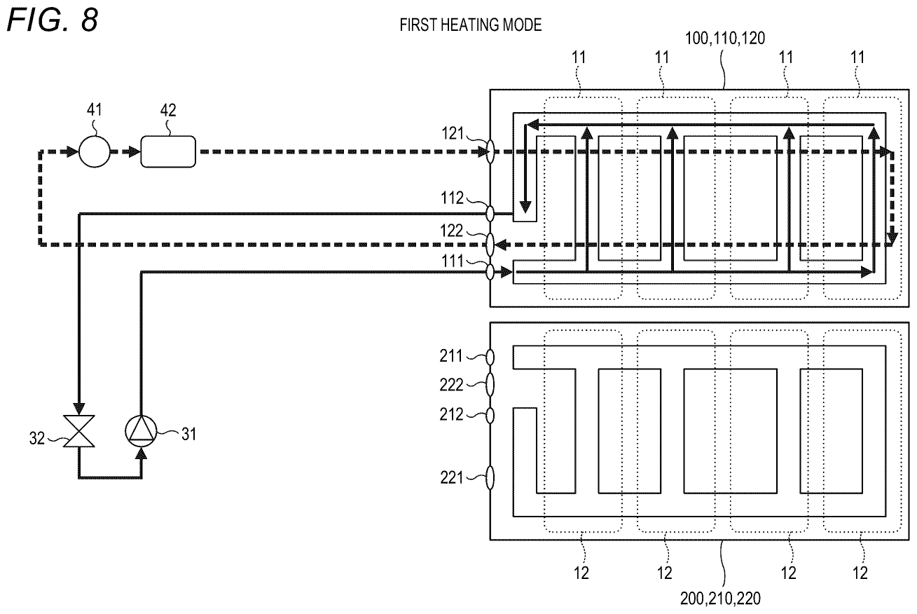

FIG. 8 is a schematic diagram showing an example of a refrigerant circuit and a coolant circuit in a first heating mode according to the first embodiment.

The first heating mode is performed when the temperatures of the first battery packs 11 and the second battery packs 12 are equal to or lower than a first threshold temperature. The first threshold temperature corresponds to a lower limit of a temperature suitable for efficient charging of the secondary battery, and is, for example, 5° C. However, the first threshold temperature may be lower than 5° C. or higher than 5° C. The temperature of first battery packs 11 may be measured by a temperature sensor (not shown) attached to first battery packs 11. The temperature of the second battery packs 12 may be measured by a temperature sensor (not shown) attached to the second battery packs 12.

In the first heating mode, the refrigerant is circulated through the first refrigerant layer 110 of the first heat exchange plate 100 at a first flow rate. In the first heating mode, a temperature of the refrigerant entering the first refrigerant layer 110 is higher than the temperature of the first battery packs 11. Specifically, as shown in FIG. 8, the control device 10 forms the refrigerant circuit that allows the refrigerant to circulate through a compressor 31 that compresses the refrigerant, the first refrigerant input portion 111, the refrigerant passages of the first refrigerant layer 110, the first refrigerant output portion 112, and an expansion valve 32 that expands the refrigerant in this order as the first heating mode. For example, when the refrigerant at 80° C. enters the first refrigerant input portion 111 and moves through the refrigerant passages of the first refrigerant layer 110, the refrigerant exchanges heat with the coolant of the first coolant layer 120, and for example, the refrigerant at 50° C. exits from the first refrigerant output portion 112. The control device 10 may form the refrigerant circuit shown in FIG. 8 by controlling a three-way valve, a four-way valve, or the like (not shown).

In the first heating mode, the refrigerant may be circulated through the second refrigerant layer 210 of the second heat exchange plate 200 at a second flow rate smaller than the first flow rate. However, the second flow rate may be zero. That is, in the first heating mode, there may be little or no refrigerant flowing through the second refrigerant layer 210 of the second heat exchange plate 200.

In addition, in the first heating mode, the coolant is circulated through the first coolant layer 120 of the first heat exchange plate 100. Specifically, as shown in FIG. 8, the control device 10 forms the coolant circuit that allows the coolant to circulate through a pump 41 that moves the coolant, a heater 42 that heats the coolant, the first coolant input portion 121, the coolant passages of the first coolant layer 120, and the first coolant output portion 122 in this order as the first heating mode. Here, the control device 10 may operate the heater 42 to heat the coolant. For example, when the coolant at 40° C. enters the first coolant input portion 121 and moves through the coolant passages of the first coolant layer 120, the coolant exchanges heat with the refrigerant of the first refrigerant layer 110 and the first battery packs 11 (that is, heats the first battery packs 11), and for example, the coolant at 20° C. exits from the first coolant output portion 122. The control device 10 may form the coolant circuit shown in FIG. 8 by controlling a three-way valve, a four-way valve, or the like (not shown).

The first heating mode may continue until the temperature of the first battery packs 11 becomes higher than a charge threshold temperature. The charge threshold temperature may be higher than the first threshold temperature (for example, 5° C.) or may be the same as the first threshold temperature. Accordingly, in the first heating mode, the first battery packs 11 are heated to a temperature higher than the charge threshold temperature. Charging of the first battery packs 11 may be started when the temperature becomes higher than the charge threshold temperature.

As described above, in the first heating mode, the plurality of first battery packs 11 disposed on the first heat exchange plate 100 exchange heat with the third surface 103 of which the temperature is made substantially uniform by the first coolant layer 120, and thus are heated with less temperature variation. Accordingly, the temperature of the plurality of first battery packs 11 can be efficiently made higher than the charge threshold temperature.

### <Second Heating Mode>

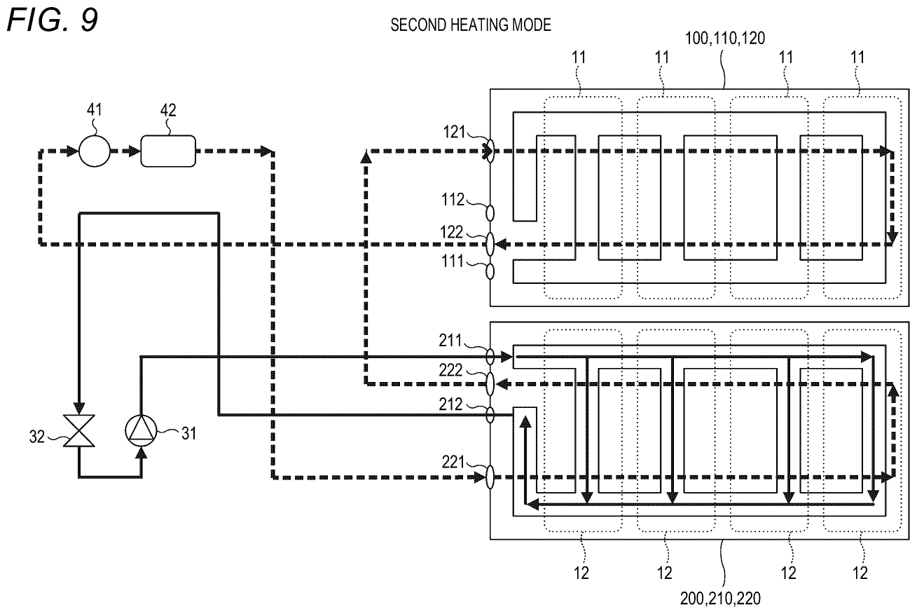

FIG. 9 is a schematic diagram showing an example of a refrigerant circuit and a coolant circuit in a second heating mode according to the first embodiment.

The second heating mode is started when the temperature of the first battery packs 11 becomes higher than the charge threshold temperature in the first heating mode. As described above, the charge threshold temperature may be higher than the first threshold temperature (for example, 5° C.) or may be the same as the first threshold temperature.

In the second heating mode, the refrigerant is circulated through the second refrigerant layer 210 of the second heat exchange plate 200 at a fourth flow rate. Here, in the second heating mode, the temperature of the refrigerant entering the second refrigerant layer 210 is higher than the temperature of the second battery packs 12. Specifically, as shown in FIG. 9, the control device 10 forms a refrigerant circuit that allows the refrigerant to circulate through the compressor 31, the second refrigerant input portion 211, the refrigerant passages of the second refrigerant layer 210, the second refrigerant output portion 212, and the expansion valve 32 in this order as the second heating mode. For example, when the refrigerant at 80° C. enters the second refrigerant input portion 211 and moves through the refrigerant passages of the second refrigerant layer 210, the refrigerant exchanges heat with the coolant of the second coolant layer 220, and for example, the refrigerant at 50° C. exits from the second refrigerant output portion 212. The control device 10 may form the refrigerant circuit shown in FIG. 9 by controlling a three-way valve, a four-way valve, or the like (not shown).

In the second heating mode, the refrigerant may be circulated through the first refrigerant layer 110 of the first heat exchange plate 100 at a third flow rate smaller than the fourth flow rate. In other words, the fourth flow rate may be larger than the third flow rate. However, the third flow rate may be zero. That is, in the second heating mode, there may be little or no refrigerant flowing through the first refrigerant layer 110 of the first heat exchange plate 100.

In addition, in the second heating mode, the coolant is circulated through the second coolant layer 220 of the second heat exchange plate 200 and the first coolant layer 120 of the first heat exchange plate 100. Specifically, as shown in FIG. 9, the control device 10 forms a coolant circuit that allows the coolant to circulate through the pump 41, the heater 42, the second coolant input portion 221, the coolant passages of the second coolant layer 220, the second coolant output portion 222, the first coolant input portion 121, the coolant passages of the first coolant layer 120, and the first coolant output portion 122 in this order as the second heating mode. Here, the control device 10 may operate the heater 42 to heat the coolant. For example, when the coolant at 40° C. enters the second coolant input portion 221 and moves through the coolant passages of the second coolant layer 220, the coolant exchanges heat with the refrigerant of the second refrigerant layer 210 and the second battery packs 12 (that is, heats the second battery packs 12), and for example, the coolant at 20° C. exits from the second coolant output portion 222. When the coolant at 20° C. enters the first coolant input portion 121 and moves through the coolant passages of the first coolant layer 120, the coolant exchanges heat with the first battery packs 11 (that is, cools the first battery packs 11), and for example, the coolant at 30° C. exits from the first coolant output portion 122. The control device 10 may form the coolant circuit shown in FIG. 9 by controlling a three-way valve, a four-way valve, or the like (not shown).

The second heating mode continues until the temperature of the second battery packs 12 becomes higher than a charge threshold temperature. The charge threshold temperature in the second heating mode may be the same as or different from the charge threshold temperature in the first heating mode. Accordingly, in the second heating mode, the second battery packs 12 are heated to a temperature higher than the charge threshold temperature. Charging of the second battery packs 12 may be started when the temperature becomes higher than the charge threshold temperature.

In the second heating mode, the coolant obtains heat from the first battery packs 11 being charged while moving in the first coolant layer 120, and then enters the second coolant layer 220 to heat the second battery packs 12. Further, in the second heating mode, the coolant is deprived of heat by the second battery pack 12 while moving in the second coolant layer 220, and then enters the first coolant layer 120 to cool the first battery packs 11 so that the temperature of the first battery packs 11 being charged does not rise excessively. As described above, in the second heating mode, it is possible to efficiently heat the second battery packs 12 and cool the first battery packs 11 being charged by circulating the coolant.

### <Cooling Mode>

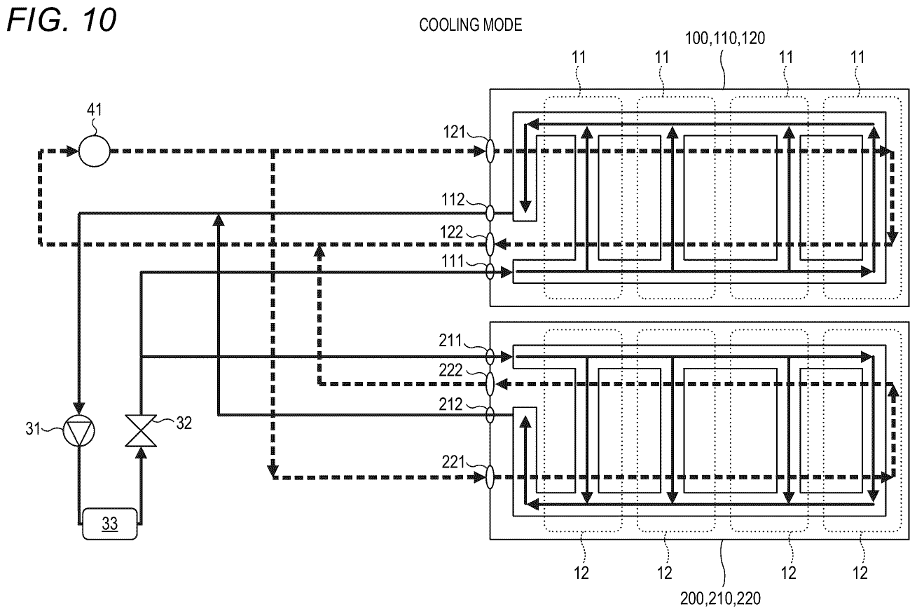

FIG. 10 is a schematic diagram showing an example of a refrigerant circuit and a coolant circuit in a cooling mode according to the first embodiment.

The cooling mode may be started when the temperature of the first battery packs 11 and/or the second battery packs 12 becomes higher than a cooling threshold temperature. The cooling threshold temperature may be higher than the charge threshold temperature or may be the same as the charge threshold temperature. Further, the charge threshold temperature for the first battery packs 11 and the charge threshold temperature for the second battery packs 12 may be the same or different. The charge threshold temperature corresponds to an upper limit of a temperature at which deterioration of the secondary battery can be prevented, and charging and discharging can be stably performed, and may be, for example, 50° C. However, the charge threshold temperature may be lower than 50° C. or higher than 50° C. In the cooling mode, the first battery packs 11 and the second battery packs 12 are cooled so that the temperatures of the first battery packs 11 and the second battery packs 12 during charging and discharging do not rise excessively.

In the cooling mode, the refrigerant is circulated through the first refrigerant layer 110 of the first heat exchange plate 100. In the cooling mode, the temperature of the refrigerant entering the first refrigerant layer 110 is lower than the temperature of the first battery packs 11. Specifically, as shown in FIG. 10, the control device 10 forms a refrigerant circuit that allows the refrigerant to circulate through an external condenser 33 capable of exchanging heat with air outside the vehicle, the expansion valve 32, the first refrigerant input portion 111, the refrigerant passages of the first refrigerant layer 110, the first refrigerant output portion 112, and the compressor 31 in this order as the cooling mode. For example, when the refrigerant at 0° C. enters the first refrigerant input portion 111 and moves through the refrigerant passages of the first refrigerant layer 110, the refrigerant exchanges heat with the coolant of the first coolant layer 120, and for example, the refrigerant at 20° C. exits from the first refrigerant output portion 112. The control device 10 may form the refrigerant circuit shown in FIG. 10 by controlling a three-way valve, a four-way valve, or the like (not shown).

In addition, in the cooling mode, the refrigerant is circulated through the second refrigerant layer 210 of the second heat exchange plate 200. In the cooling mode, the temperature of the refrigerant entering the second refrigerant layer 210 is lower than the temperature of the second battery packs 12. Specifically, as shown in FIG. 10, the control device 10 forms a refrigerant circuit that allows the refrigerant to circulate through the external condenser 33, the expansion valve 32, the second refrigerant input portion 211, the refrigerant passages of the second refrigerant layer 210, the second refrigerant output portion 212, and the compressor 31 in this order as the cooling mode. For example, when the refrigerant at 0° C. enters the second refrigerant input portion 211 and moves through the refrigerant passages of the second refrigerant layer 210, the refrigerant exchanges heat with the coolant of the second coolant layer 220, and for example, the refrigerant at 20° C. exits from the first refrigerant output portion 112. The control device 10 may form the refrigerant circuit shown in FIG. 10 by controlling a three-way valve, a four-way valve, or the like (not shown).

In addition, in the cooling mode, the coolant is circulated through the first coolant layer 120 of the first heat exchange plate 100. Specifically, as shown in FIG. 10, the control device 10 forms a coolant circuit that allows the coolant to circulate through the pump 41, the first coolant input portion 121, the coolant passages of the first coolant layer 120, and the first coolant output portion 122 in this order as the cooling mode. For example, when the coolant enters the first coolant input portion 121 and moves through the coolant passages of the first coolant layer 120, the coolant exchanges heat with the refrigerant of the first refrigerant layer 110 and the first battery packs 11 (for example, cools the first battery packs 11), and exits from the first coolant output portion 122. Accordingly, the first battery packs 11 can be cooled substantially uniformly, and the first battery packs 11 can be prevented from becoming too hot.

In addition, in the cooling mode, the coolant is circulated through the second coolant layer 220 of the second heat exchange plate 200. Specifically, as shown in FIG. 10, the control device 10 forms a coolant circuit that allows the coolant to circulate through the pump 41, the second coolant input portion 221, the coolant passages of the second coolant layer 220, and the second coolant output portion 222 in this order as the cooling mode. For example, when the coolant enters the second coolant input portion 221 and moves through the coolant passages of the second coolant layer 220, the coolant exchanges heat with the refrigerant of the second refrigerant layer 210 and the second battery packs 12 (for example, cools the second battery packs 12), and exits from the second coolant output portion 222. Accordingly, the second battery packs 12 can be cooled substantially uniformly, and the second battery packs 12 can be prevented from becoming too hot.

The numerical values of the temperatures described above are described for easy understanding of the description, and the present embodiment is not limited to the numerical values of the temperatures.

### (Summary of First Embodiment)

The following techniques are disclosed from the above description of the first embodiment.

### <Technique 1>

The first embodiment provides a vehicle control method executable in a vehicle (1), in which
the vehicle (1) includes
   a vehicle body (2),
   a first wheel (3a) and a second wheel (3b) coupled to the vehicle body,
   a first battery pack (11) disposed along a first surface in the vehicle body,
   a second battery pack (12) disposed along a second surface in the vehicle body,
   a first heat exchange plate (100) disposed along the first surface in the vehicle body,
   a second heat exchange plate (200) disposed along the second surface in the vehicle body, and
   an electric motor (4) that drives at least the first wheel using electric power supplied from the first battery pack and/or the second battery pack,
the vehicle (1) is movable by the first wheel and the second wheel in a predetermined direction,
the first heat exchange plate includes
   a third surface (103) disposed along the first surface and capable of exchanging heat with the first battery pack,
   a fourth surface (104) disposed along the first surface and opposite to the third surface,
   a first refrigerant layer (110) in which a refrigerant circulates between the third surface and the fourth surface, and
   a first coolant layer (120) in which a coolant circulates between the third surface and the fourth surface,
the second heat exchange plate includes
   a fifth surface (205) disposed along the second surface and capable of exchanging heat with the second battery pack,
   a sixth surface (206) disposed along the second surface and opposite to the fifth surface,
   a second refrigerant layer (210) in which the refrigerant circulates between the fifth surface and the sixth surface, and
   a second coolant layer (220) in which the coolant circulates between the fifth surface and the sixth surface, and
the vehicle control method includes:
   when a first temperature of the first battery pack and the second battery pack is lower than a first threshold temperature, causing the refrigerant to circulate through the first refrigerant layer of the first heat exchange plate at a first flow rate, and causing the refrigerant to circulate through the second refrigerant layer of the second heat exchange plate at a second flow rate lower than the first flow rate, a second temperature of the refrigerant entering the first refrigerant layer being higher than the first temperature of the first battery pack; and
   when a third temperature of the first battery pack is higher than a second threshold temperature higher than the first threshold temperature, charging the first battery pack and causing the coolant to circulate through the first coolant layer and the second coolant layer in this order.

Accordingly, first, the first battery pack is heated to a temperature appropriate for charging by the first heat exchange plate, and then the coolant is circulated through the first coolant layer and the second coolant layer in this order during the charging of the first battery pack, so that heat obtained from the first battery pack during the charging when the coolant moves through the first coolant layer can be used in the second coolant layer to heat the second battery pack. Accordingly, the first battery pack and the second battery pack can be efficiently heated.

### <Technique 2>

The vehicle control method according to the technique 1, further including:
when the first temperature of the first battery pack and the second battery pack is lower than the first threshold temperature, causing the refrigerant to circulate through the first refrigerant layer of the first heat exchange plate at the first flow rate, and causing the coolant to circulate through the first coolant layer of the first heat exchange plate.

Accordingly, the first heat exchange plate can substantially uniformly heat the first battery pack to the temperature appropriate for the charging.

### <Technique 3>

The vehicle control method according to the technique 1 or 2, further including: when the third temperature of the first battery pack is higher than the second threshold temperature, charging the first battery pack; and when a fourth temperature of the first battery pack is higher than a third threshold temperature higher than the second threshold temperature, causing the refrigerant to circulate through the first refrigerant layer of the first heat exchange plate, a fifth temperature of the refrigerant entering the first refrigerant layer being lower than the fourth temperature of the first battery pack.

Accordingly, the first heat exchange plate can substantially uniformly cool the first battery pack.

### <Technique 4>

The vehicle control method according to any one of the techniques 1 to 3, further including:
when the third temperature of the first battery pack is higher than the second threshold temperature, charging the first battery pack, causing the coolant to circulate through the first coolant layer and the second coolant layer in this order, causing the refrigerant to circulate through the first refrigerant layer of the first heat exchange plate at a third flow rate, and causing the refrigerant to circulate through the second refrigerant layer of the second heat exchange plate at a fourth flow rate higher than the third flow rate, a sixth temperature of the refrigerant entering the second refrigerant layer being higher than a seventh temperature of the second battery pack.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to a temperature appropriate for charging.

### <Technique 5>

The vehicle control method according to the technique 4, further including:
when the third temperature of the first battery pack is higher than the second threshold temperature, charging the first battery pack, causing the coolant to circulate through the first coolant layer and the second coolant layer in this order, and causing the refrigerant to circulate through the second refrigerant layer of the second heat exchange plate at the fourth flow rate; and
when the seventh temperature of the second battery pack is higher than a fourth threshold temperature higher than the first threshold temperature, charging the second battery pack.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 6>

The vehicle control method according to the technique 5, further including:
when the seventh temperature of the second battery pack is higher than the fourth threshold temperature, charging the second battery pack; and
when an eighth temperature of the second battery pack is higher than a fifth threshold temperature higher than the fourth threshold temperature, causing the refrigerant to circulate through the second refrigerant layer of the second heat exchange plate, a ninth temperature of the refrigerant entering the second refrigerant layer being lower than the eighth temperature of the second battery pack.

Accordingly, the second heat exchange plate can substantially uniformly cool the second battery pack.

### <Technique 7>

The vehicle control method according to any one of the techniques 1 to 6, in which
the first heat exchange plate (100) includes
   a first refrigerant input portion (111) that allows the refrigerant to enter the first refrigerant layer,
   a first refrigerant output portion (112) that allows the refrigerant to exit from the first refrigerant layer,
   a first coolant input portion (121) that allows the coolant to enter the first coolant layer, and
   a first coolant output portion (122) that allows the coolant to exit from the first coolant layer,
the second heat exchange plate (200) includes
   a second refrigerant input portion (211) that allows the refrigerant to enter the second refrigerant layer,
   a second refrigerant output portion (212) that allows the refrigerant to exit from the second refrigerant layer,
   a second coolant input portion (221) that allows the coolant to enter the second coolant layer, and
   a second coolant output portion (222) that allows the coolant to exit from the second coolant layer, and
a coolant circuit is formed in which when the third temperature of the first battery pack is higher than the second threshold temperature, the coolant enters the first coolant input portion, exits from the first coolant output portion through the first coolant layer, enters the second coolant input portion, and exits from the second coolant output portion through the second coolant layer.

In this way, the coolant is circulated through the first coolant layer and the second coolant layer in this order during the charging of the first battery pack, so that the heat obtained from the first battery pack during the charging when the coolant moves through the first coolant layer can be used in the second coolant layer to heat the second battery pack. Accordingly, the second battery pack can be efficiently heated.

### <Technique 8>

The vehicle control method according to the technique 7, in which
a heater capable of heating the coolant entering the second coolant input portion is further provided.

Accordingly, the coolant entering the first coolant layer can be heated by the heater.

### <Technique 9>

The vehicle control method according to any one of the techniques 1 to 8, in which
the first heat exchange plate is disposed along the predetermined direction, and
the second heat exchange plate is disposed along the predetermined direction.

Accordingly, the first heat exchange plate and the second heat exchange plate are disposed along the same predetermined direction (for example, the front-rear direction of the vehicle 1).

### <Technique 10>

The vehicle control method according to any one of the techniques 1 to 8, in which
the first heat exchange plate is disposed along a direction orthogonal to the predetermined direction,
the second heat exchange plate is disposed along the direction orthogonal to the predetermined direction, and
the orthogonal direction is a horizontal direction.

Accordingly, the first heat exchange plate and the second heat exchange plate are disposed along the direction orthogonal to the same predetermined direction (for example, the width direction of the vehicle 1).

### <Technique 11>

The first embodiment provides a vehicle control device (for example, the control device 10) set to be mounted in a vehicle (1), in which
the vehicle (1) includes
   a vehicle body (2),
   a first wheel (3a) and a second wheel (3b) coupled to the vehicle body,
   a first battery pack (11) disposed along a first surface in the vehicle body,
   a second battery pack (12) disposed along a second surface in the vehicle body,
   a first heat exchange plate (100) disposed along the first surface in the vehicle body,
   a second heat exchange plate (200) disposed along the second surface in the vehicle body, and
   an electric motor (4) that drives at least the first wheel using electric power supplied from the first battery pack and/or the second battery pack,
the vehicle (1) is movable by the first wheel and the second wheel in a predetermined direction,
the first heat exchange plate includes
   a third surface (103) disposed along the first surface and capable of exchanging heat with the first battery pack,
   a fourth surface (104) disposed along the first surface and opposite to the third surface,
   a first refrigerant layer (110) in which a refrigerant circulates between the third surface and the fourth surface, and
   a first coolant layer (120) in which a coolant circulates between the third surface and the fourth surface,
the second heat exchange plate includes
   a fifth surface (205) disposed along the second surface and capable of exchanging heat with the second battery pack,
   a sixth surface (206) disposed along the second surface and opposite to the fifth surface,
   a second refrigerant layer (210) in which the refrigerant circulates between the fifth surface and the sixth surface, and
   a second coolant layer (220) in which the coolant circulates between the fifth surface and the sixth surface,
when a first temperature of the first battery pack and the second battery pack is lower than a first threshold temperature, the refrigerant is circulated through the first refrigerant layer of the first heat exchange plate at a first flow rate, and is circulated through the second refrigerant layer of the second heat exchange plate at a second flow rate lower than the first flow rate, and a second temperature of the refrigerant entering the first refrigerant layer is higher than the first temperature of the first battery pack, and
when a third temperature of the first battery pack is higher than a second threshold temperature higher than the first threshold temperature, the first battery pack is charged, and the coolant is circulated through the first coolant layer and the second coolant layer in this order.

Accordingly, first, the first battery pack is heated to a temperature appropriate for charging by the first heat exchange plate, and then the coolant is circulated through the first coolant layer and the second coolant layer in this order during the charging of the first battery pack, so that heat obtained from the first battery pack during the charging when the coolant moves through the first coolant layer can be used in the second coolant layer to heat the second battery pack. Accordingly, the first battery pack and the second battery pack can be efficiently heated.

### <Technique 12>

The vehicle control device according to the technique 11, in which
when the first temperature of the first battery pack and the second battery pack is lower than the first threshold temperature, the refrigerant is circulated through the first refrigerant layer of the first heat exchange plate at the first flow rate, and the coolant is circulated through the first coolant layer of the first heat exchange plate.

Accordingly, the first heat exchange plate can substantially uniformly heat the first battery pack to the temperature appropriate for the charging.

### <Technique 13>

The vehicle control device according to the technique 11 or 12, in which
when the third temperature of the first battery pack is higher than the second threshold temperature, the first battery pack is charged, and when a fourth temperature of the first battery pack is higher than a third threshold temperature higher than the second threshold temperature, the refrigerant is circulated through the first refrigerant layer of the first heat exchange plate, and a fifth temperature of the refrigerant entering the first refrigerant layer is lower than the fourth temperature of the first battery pack.

Accordingly, the first heat exchange plate can substantially uniformly cool the first battery pack.

### <Technique 14>

The vehicle control device according to any one of the techniques 11 to 13, in which
when the third temperature of the first battery pack is higher than the second threshold temperature, the first battery pack is charged, the coolant is circulated through the first coolant layer and the second coolant layer in this order, the refrigerant is circulated through the first refrigerant layer of the first heat exchange plate at a third flow rate, and is circulated through the second refrigerant layer of the second heat exchange plate at a fourth flow rate higher than the third flow rate, and a sixth temperature of the refrigerant entering the second refrigerant layer is higher than a seventh temperature of the second battery pack.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 15>

The vehicle control device according to the technique 14, in which
when the third temperature of the first battery pack is higher than the second threshold temperature, the first battery pack is charged, the coolant is circulated through the first coolant layer and the second coolant layer in this order, and the refrigerant is circulated through the second refrigerant layer of the second heat exchange plate at the fourth flow rate, and
when the seventh temperature of the second battery pack is higher than a fourth threshold temperature higher than the first threshold temperature, the second battery pack is charged.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 16>

The vehicle control device according to the technique 15, in which
when the seventh temperature of the second battery pack is higher than the fourth threshold temperature, the second battery pack is charged, and
when an eighth temperature of the second battery pack is higher than a fifth threshold temperature higher than the fourth threshold temperature, the refrigerant is circulated through the second refrigerant layer of the second heat exchange plate, and a ninth temperature of the refrigerant entering the second refrigerant layer is lower than the eighth temperature of the second battery pack.

Accordingly, the second heat exchange plate can substantially uniformly cool the second battery pack.

### <Technique 17>

The vehicle control device according to any one of the techniques 11 to 16, in which
the first heat exchange plate includes
   a first refrigerant input portion that allows the refrigerant to enter the first refrigerant layer,
   a first refrigerant output portion that allows the refrigerant to exit from the first refrigerant layer,
   a first coolant input portion that allows the coolant to enter the first coolant layer, and
   a first coolant output portion that allows the coolant to exit from the first coolant layer,
the second heat exchange plate includes
   a second refrigerant input portion that allows the refrigerant to enter the second refrigerant layer,
   a second refrigerant output portion that allows the refrigerant to exit from the second refrigerant layer,
   a second coolant input portion that allows the coolant to enter the second coolant layer, and
   a second coolant output portion that allows the coolant to exit from the second coolant layer, and
a coolant circuit is formed in which when the third temperature of the first battery pack is higher than the second threshold temperature, the coolant enters the first coolant input portion, exits from the first coolant output portion through the first coolant layer, enters the second coolant input portion, and exits from the second coolant output portion through the second coolant layer.

In this way, the coolant is circulated through the first coolant layer and the second coolant layer in this order during the charging of the first battery pack, so that the heat obtained from the first battery pack during the charging when the coolant moves through the first coolant layer can be used in the second coolant layer to heat the second battery pack. Accordingly, the second battery pack can be efficiently heated.

### <Technique 18>

The vehicle control device according to the technique 17, in which a heater capable of heating the coolant entering the second coolant input portion is further provided.

Accordingly, the coolant entering the first coolant layer can be heated by the heater.

### <Technique 19>

The vehicle control device according to any one of the techniques 11 to 18, in which
the first heat exchange plate is disposed along the predetermined direction, and
the second heat exchange plate is disposed along the predetermined direction.

Accordingly, the first heat exchange plate and the second heat exchange plate are disposed along the same predetermined direction (for example, the front-rear direction of the vehicle 1).

### <Technique 20>

The vehicle control device according to any one of the techniques 11 to 18, in which
the first heat exchange plate is disposed along a direction orthogonal to the predetermined direction,
the second heat exchange plate is disposed along the direction orthogonal to the predetermined direction, and
the orthogonal direction is a horizontal direction.

Accordingly, the first heat exchange plate and the second heat exchange plate are disposed along the direction orthogonal to the same predetermined direction (for example, the width direction of the vehicle 1).

### Second Embodiment

In a second embodiment, a configuration in which a first heating mode, a second heating mode, and a cooling mode are performed by a method different from that of the first embodiment will be described. Since the configuration of the vehicle 1 and the configurations of the first heat exchange plate 100 and the second heat exchange plate 200 are substantially the same as those of the first embodiment, the description thereof will be omitted in the second embodiment.

### <First Heating Mode>

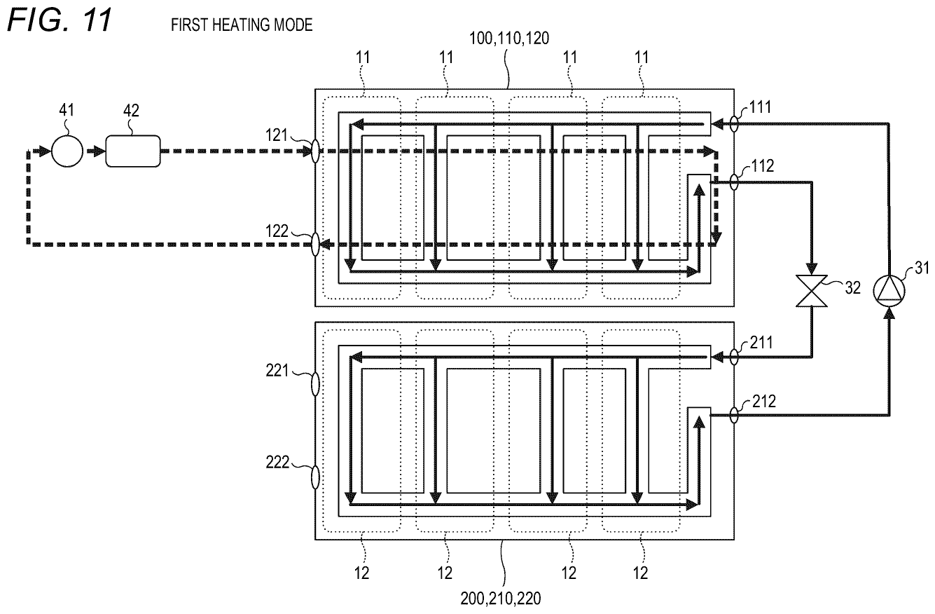

FIG. 11 is a schematic diagram showing an example of a refrigerant circuit and a coolant circuit in a first heating mode according to the second embodiment.

The first heating mode is performed when first temperatures of the first battery packs 11 and the second battery packs 12 are equal to or lower than a first threshold temperature. The first threshold temperature corresponds to a lower limit of a temperature suitable for efficient charging of the secondary battery, and is, for example, 5° C. However, the first threshold temperature may be lower than 5° C. or higher than 5° C. The temperature of first battery packs 11 may be measured by a temperature sensor (not shown) attached to first battery packs 11. The temperature of the second battery packs 12 may be measured by a temperature sensor (not shown) attached to the second battery packs 12.

In the first heating mode, a refrigerant is circulated through the first refrigerant layer 110 of the first heat exchange plate 100 and the second refrigerant layer 210 of the second heat exchange plate 200. In the first heating mode, a temperature of the refrigerant entering the first refrigerant layer 110 is higher than the temperature of the first battery packs 11. Specifically, as shown in FIG. 11, the control device 10 forms a refrigerant circuit that allows the refrigerant to circulate through the compressor 31, the first refrigerant input portion 111, the refrigerant passages of the first refrigerant layer 110, the first refrigerant output portion 112, the expansion valve 32, the second refrigerant input portion 211, the refrigerant passages of the second refrigerant layer 210, and the second refrigerant output portion 212 in this order as the first heating mode. For example, when the refrigerant at 80° C. enters the first refrigerant input portion 111 and moves through the refrigerant passages of the first refrigerant layer 110, the refrigerant exchanges heat with a coolant of the first coolant layer 120, and for example, the refrigerant at 50° C. exits from the first refrigerant output portion 112. Then, the refrigerant at 50° C. which has exited from the first refrigerant output portion 112 becomes, for example, 0° C. by the expansion valve 32, enters the second refrigerant input portion 211, moves through the refrigerant passages of the second refrigerant layer 210, and exits from the second refrigerant output portion 212. In this case, the second refrigerant layer 210 not used for heating may function as an evaporator. The control device 10 may form the refrigerant circuit shown in FIG. 11 by controlling a three-way valve, a four-way valve, or the like (not shown).

In addition, in the first heating mode, the coolant is circulated through the first coolant layer 120 of the first heat exchange plate 100. Specifically, as shown in FIG. 11, the control device 10 forms a coolant circuit that allows the coolant to circulate through the pump 41, the heater 42, the first coolant input portion 121, the coolant passages of the first coolant layer 120, and the first coolant output portion 122 in this order as the first heating mode. Here, the control device 10 may operate the heater 42 to heat the coolant. For example, when the coolant at 40° C. enters the first coolant input portion 121 and moves through the coolant passages of the first coolant layer 120, the coolant exchanges heat with the refrigerant of the first refrigerant layer 110 and the first battery packs 11 (that is, warms the first battery packs 11), and for example, the coolant at 20° C. exits from the first coolant output portion 122. The control device 10 may form the coolant circuit shown in FIG. 11 by controlling a three-way valve, a four-way valve, or the like (not shown).

The first heating mode may continue until the temperature of the first battery packs 11 becomes higher than a charge threshold temperature. The charge threshold temperature may be higher than the first threshold temperature (for example, 5° C.) or may be the same as the first threshold temperature. Accordingly, in the first heating mode, the first battery packs 11 are heated to a temperature higher than the charge threshold temperature. Charging of the first battery packs 11 may be started when the temperature becomes higher than the charge threshold temperature.

As described above, in the first heating mode, the plurality of first battery packs 11 disposed on the first heat exchange plate 100 exchange heat with the third surface 103 of which a temperature is made substantially uniform by the first coolant layer 120, and thus are heated with less temperature variation. Accordingly, the temperature of the plurality of first battery packs 11 can be efficiently made higher than the charge threshold temperature.

### <Second Heating Mode>

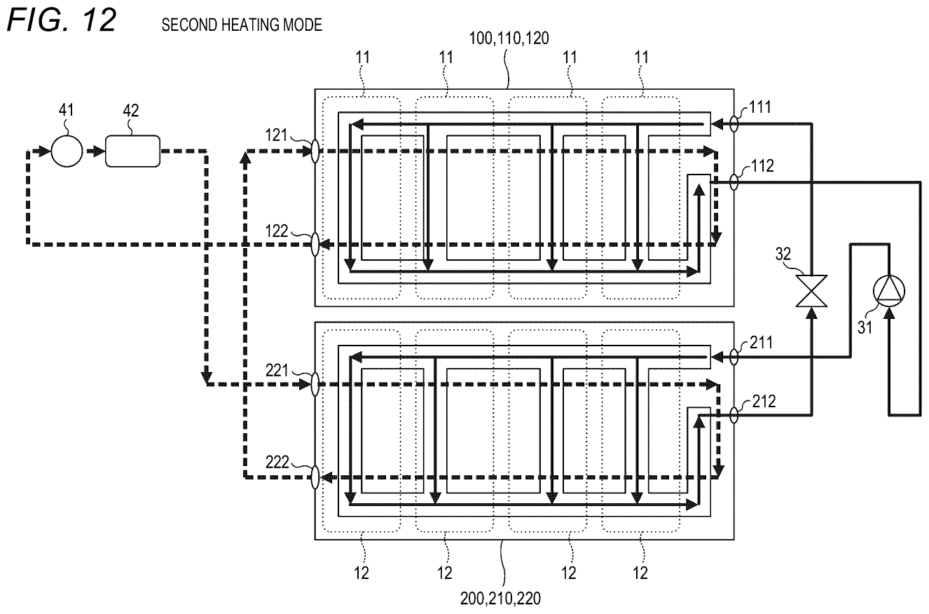

FIG. 12 is a schematic diagram showing an example of a refrigerant circuit and a coolant circuit in a second heating mode according to the second embodiment.

The second heating mode is started when the temperature of the first battery packs becomes higher than the charge threshold temperature in the first heating mode. As described above, the charge threshold temperature may be higher than the first threshold temperature (for example, 5° C.) or may be the same as the first threshold temperature.

In the second heating mode, the refrigerant is circulated through the second refrigerant layer 210 of the second heat exchange plate 200 and the first refrigerant layer 110 of the first heat exchange plate 100. In the second heating mode, the temperature of the refrigerant entering the second refrigerant layer 210 is higher than the temperature of the second battery packs 12. Specifically, as shown in FIG. 12, the control device 10 forms the refrigerant circuit that allows the refrigerant to circulate through the compressor 31, the second refrigerant input portion 211, the refrigerant passages of the second refrigerant layer 210, the second refrigerant output portion 212, the expansion valve 32, the first refrigerant input portion 111, the refrigerant passages of the first refrigerant layer 110, and the first refrigerant output portion 112 in this order as the second heating mode. For example, when the refrigerant at 80° C. enters the second refrigerant input portion 211 and moves through the refrigerant passages of the second refrigerant layer 210, the refrigerant exchanges heat with the coolant of the second coolant layer 220, and for example, the refrigerant at 50° C. exits from the second refrigerant output portion 212. Then, when the refrigerant at 50° C. that has exited from the second refrigerant output portion 212 becomes, for example, 0° C. by the expansion valve 32, enters the first refrigerant input portion 111, and moves through the refrigerant passages of the first refrigerant layer 110, the refrigerant exchanges heat with the coolant of the first coolant layer 120, and for example, the refrigerant at 20° C. exits from the first refrigerant output portion 112. In this case, the second refrigerant layer 210 functions as a condenser and contributes to heating of the second battery pack 12, and the first refrigerant layer 110 functions as an evaporator and contributes to cooling of the first battery pack 11 during the charging. The control device 10 may form the refrigerant circuit shown in FIG. 12 by controlling a three-way valve, a four-way valve, or the like (not shown).

In addition, in the second heating mode, the coolant is circulated through the second coolant layer 220 of the second heat exchange plate 200 and the first coolant layer 120 of the first heat exchange plate 100. Specifically, as shown in FIG. 12, the control device 10 forms the coolant circuit that allows the coolant to circulate through the pump 41, the heater 42, the second coolant input portion 221, the coolant passages of the second coolant layer 220, the second coolant output portion 222, the first coolant input portion 121, the coolant passages of the first coolant layer 120, and the first coolant output portion 122 in this order. Here, the control device 10 may operate the heater 42 to heat the coolant. For example, when the coolant at 40° C. enters the second coolant input portion 221 and moves through the coolant passages of the second coolant layer 220, the coolant exchanges heat with the refrigerant of the second refrigerant layer 210 and the second battery packs 12 (that is, heats the second battery packs 12), and for example, the coolant at 20° C. exits from the second coolant output portion 222. When the coolant at 20° C. enters the first coolant input portion 121 and moves through the coolant passages of the first coolant layer 120, the coolant exchanges heat with the first battery packs 11 (that is, cools the first battery packs 11 during the charging), and for example, the coolant at 30° C. exits from the first coolant output portion 122.

The second heating mode continues until the temperature of the second battery packs 12 becomes higher than a charge threshold temperature. The charge threshold temperature in the second heating mode may be the same as or different from the charge threshold temperature in the first heating mode. Accordingly, in the second heating mode, the second battery packs 12 are heated to a temperature higher than the charge threshold temperature. Charging of the second battery packs 12 may be started when the temperature becomes higher than the charge threshold temperature.

In the second heating mode, the coolant obtains heat from the first battery packs 11 being charged while moving in the first coolant layer 120, and then enters the second coolant layer 220 to heat the second battery packs 12. Further, in the second heating mode, the coolant is deprived of heat by the second battery pack 12 while moving in the second coolant layer 220, and then enters the first coolant layer 120 to cool the first battery packs 11 so that the temperature of the first battery packs 11 being charged does not rise excessively. As described above, in the second heating mode, it is possible to efficiently heat the second battery packs 12 and cool the first battery packs 11 during the charging by circulating the coolant.

### <Cooling Mode>

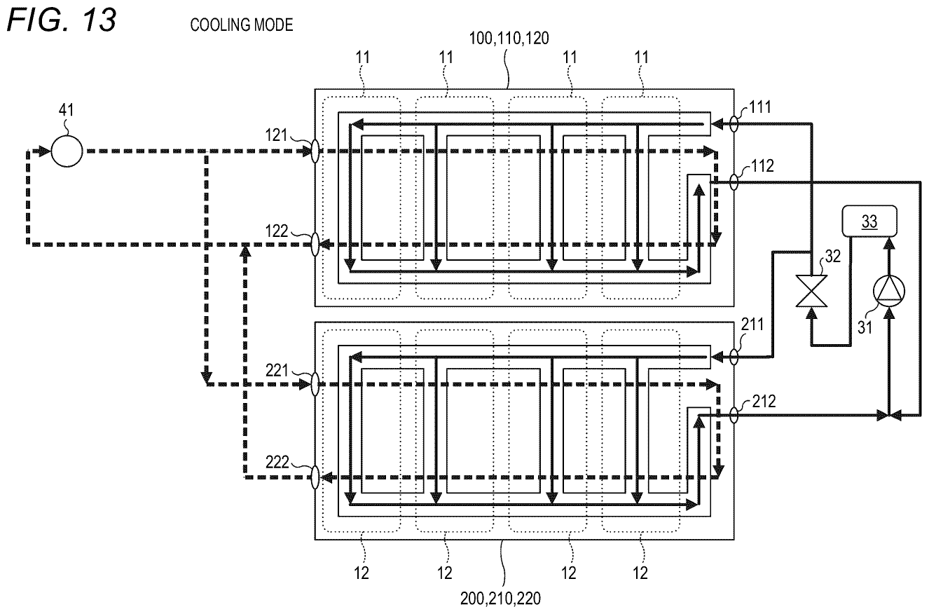

FIG. 13 is a schematic diagram showing an example of a refrigerant circuit and a coolant circuit in a cooling mode according to the second embodiment.

The cooling mode may be started when the temperature of the first battery packs 11 and/or the second battery packs 12 becomes higher than a cooling threshold temperature. The cooling threshold temperature may be higher than the charge threshold temperature or may be the same as the charge threshold temperature. Further, the charge threshold temperature for the first battery packs 11 and the charge threshold temperature for the second battery packs 12 may be the same or different. The charge threshold temperature corresponds to an upper limit of a temperature at which deterioration of the secondary battery can be prevented, and charging and discharging can be stably performed, and may be, for example, 50° C. However, the charge threshold temperature may be lower than 50° C. or higher than 50° C. In the cooling mode, the first battery packs 11 and the second battery packs 12 are cooled so that the temperatures of the first battery packs 11 and the second battery packs 12 during charging and discharging do not rise excessively.

In the cooling mode, the refrigerant is circulated through the first refrigerant layer 110 of the first heat exchange plate 100. In the cooling mode, the temperature of the refrigerant entering the first refrigerant layer 110 is lower than the temperature of the first battery packs 11. Specifically, as shown in FIG. 13, the control device 10 forms the refrigerant circuit that allows the refrigerant to circulate through the compressor 31, the external condenser 33, the expansion valve 32, the first refrigerant input portion 111, the refrigerant passages of the first refrigerant layer 110, and the first refrigerant output portion 112 in this order as the cooling mode. For example, when the refrigerant at 0° C. enters the first refrigerant input portion 111 and moves through the refrigerant passages of the first refrigerant layer 110, the refrigerant exchanges heat with the coolant of the first coolant layer 120, and for example, the refrigerant at 20° C. exits from the first refrigerant output portion 112. The control device 10 may form the refrigerant circuit shown in FIG. 13 by controlling a three-way valve, a four-way valve, or the like (not shown).

In addition, in the cooling mode, the refrigerant is circulated through the second refrigerant layer 210 of the second heat exchange plate 200. In the cooling mode, the temperature of the refrigerant entering the second refrigerant layer 210 is lower than the temperature of the second battery packs 12. Specifically, as shown in FIG. 13, the control device 10 forms the refrigerant circuit that allows the refrigerant to circulate through the compressor 31, the external condenser 33, the expansion valve 32, the second refrigerant input portion 211, the refrigerant passages of the second refrigerant layer 210, and the second refrigerant output portion 212 in this order as the cooling mode. For example, when the refrigerant at 0° C. enters the second refrigerant input portion 211 and moves through the refrigerant passages of the second refrigerant layer 210, the refrigerant exchanges heat with the coolant of the second coolant layer 220, and for example, the refrigerant at 20° C. exits from the second refrigerant output portion 212. The control device 10 may form the refrigerant circuit shown in FIG. 13 by controlling a three-way valve, a four-way valve, or the like (not shown).

In addition, in the cooling mode, the coolant is circulated through the first coolant layer 120 of the first heat exchange plate 100. Specifically, as shown in FIG. 13, the control device 10 forms the coolant circuit that allows the coolant to circulate through the pump 41, the first coolant input portion 121, the coolant passages of the first coolant layer 120, and the first coolant output portion 122 in this order as the cooling mode. For example, when the coolant enters the first coolant input portion 121 and moves through the coolant passages of the first coolant layer 120, the coolant exchanges heat with the refrigerant of the first refrigerant layer 110 and the first battery packs 11 (for example, cools the first battery packs 11), and exits from the first coolant output portion 122. Accordingly, the first battery packs 11 can be cooled substantially uniformly, and the first battery packs 11 can be prevented from becoming too hot.

In addition, in the cooling mode, the coolant is circulated through the second coolant layer 220 of the second heat exchange plate 200. Specifically, as shown in FIG. 13, the control device 10 forms the coolant circuit that allows the coolant to circulate through the pump 41, the second coolant input portion 221, the coolant passages of the second coolant layer 220, and the second coolant output portion 222 in this order as the cooling mode. For example, when the coolant enters the second coolant input portion 221 and moves through the coolant passages of the second coolant layer 220, the coolant exchanges heat with the refrigerant of the second refrigerant layer 210 and the second battery packs 12 (for example, cools the second battery packs 12), and exits from the second coolant output portion 222. Accordingly, the second battery packs 12 can be cooled substantially uniformly, and the second battery packs 12 can be prevented from becoming too hot.

The numerical values of the temperatures described above are described for easy understanding of the description, and the present embodiment is not limited to the numerical values of the temperatures.

### (Summary of Second Embodiment)

The following techniques are disclosed from the above description of the second embodiment.

### <Technique 1>

The second embodiment provides a vehicle control method executable in a vehicle (1), in which
the vehicle (1) includes
   a vehicle body (2),
   a first wheel (3a) and a second wheel (3b) coupled to the vehicle body,
   a first battery pack (11) disposed along a first surface in the vehicle body,
   a second battery pack (12) disposed along a second surface in the vehicle body,
   a first heat exchange plate (100) disposed along the first surface in the vehicle body,
   a second heat exchange plate (200) disposed along the second surface in the vehicle body, and
   an electric motor (4) that drives at least the first wheel using electric power supplied from the first battery pack and/or the second battery pack,
the vehicle (1) is movable by the first wheel and the second wheel in a predetermined direction,
the first heat exchange plate includes
   a third surface (103) disposed along the first surface and capable of exchanging heat with the first battery pack,
   a fourth surface (104) disposed along the first surface and opposite to the third surface,
   a first refrigerant layer (110) in which a refrigerant circulates between the third surface and the fourth surface, and
   a first coolant layer (120) in which a coolant circulates between the third surface and the fourth surface,
the second heat exchange plate includes
   a fifth surface (205) disposed along the second surface and capable of exchanging heat with the second battery pack,
   a sixth surface (206) disposed along the second surface and opposite to the fifth surface,
   a second refrigerant layer (210) in which the refrigerant circulates between the fifth surface and the sixth surface, and
   a second coolant layer (220) in which the coolant circulates between the fifth surface and the sixth surface, and
the vehicle control method includes:
   when a first temperature of the first battery pack and the second battery pack is lower than a first threshold temperature, causing the refrigerant to circulate through the first refrigerant layer and the second refrigerant layer in this order, a second temperature of the refrigerant entering the first refrigerant layer being higher than the first temperature of the first battery pack; and
   when a third temperature of the first battery pack is higher than a second threshold temperature higher than the first threshold temperature, charging the first battery pack and causing the coolant to circulate through the first coolant layer and the second coolant layer in this order.

Accordingly, first, the first battery pack is heated to a temperature appropriate for charging by the first heat exchange plate, and then the coolant is circulated through the first coolant layer and the second coolant layer in this order during the charging of the first battery pack, so that heat obtained from the first battery pack during the charging when the coolant moves through the first coolant layer can be used in the second coolant layer to heat the second battery pack. Accordingly, the first battery pack and the second battery pack can be efficiently heated.

### <Technique 2>

The vehicle control method according to the technique 1, further including:
when the first temperature of the first battery pack and the second battery pack is lower than the first threshold temperature, causing the refrigerant to circulate through the first refrigerant layer and the second refrigerant layer in this order, and causing the coolant to circulate through the first coolant layer of the first heat exchange plate.

Accordingly, the first heat exchange plate can substantially uniformly heat the first battery pack to the temperature appropriate for the charging.

### <Technique 3>

The vehicle control method according to the technique 1 or 2, further including:
when the third temperature of the first battery pack is higher than the second threshold temperature, charging the first battery pack, causing the coolant to circulate through the first coolant layer and the second coolant layer; and
when a fourth temperature of the second battery pack is higher than a third threshold temperature higher than the first threshold temperature, charging the second battery pack.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 4>

The vehicle control method according to any one of the techniques 1 to 3, further including:
when the third temperature of the first battery pack is higher than the second threshold temperature, charging the first battery pack; and
causing the coolant to circulate through the first coolant layer and the second coolant layer in this order, and causing the refrigerant to circulate through the second refrigerant layer and the first refrigerant layer in this order, a sixth temperature of the refrigerant entering the second refrigerant layer being higher than a seventh temperature of the second battery pack.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 5>

The vehicle control method according to the technique 4, further including:
when the third temperature of the first battery pack is higher than the second threshold temperature, charging the first battery pack, causing the coolant to circulate through the first coolant layer and the second coolant layer in this order, and causing the refrigerant to circulate through the second refrigerant layer and the first refrigerant layer in this order, the sixth temperature of the refrigerant entering the second refrigerant layer is higher than the seventh temperature of the second battery pack; and
when an eighth temperature of the second battery pack is higher than the third threshold temperature higher than the first threshold temperature, charging the second battery pack.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 6>

The vehicle control method according to any one of the techniques 1 to 5, in which
the first heat exchange plate includes
   a first refrigerant input portion (111) that allows the refrigerant to enter the first refrigerant layer,
   a first refrigerant output portion (112) that allows the refrigerant to exit from the first refrigerant layer,
   a first coolant input portion (121) that allows the coolant to enter the first coolant layer, and
   a first coolant output portion (122) that allows the coolant to exit from the first coolant layer,
the second heat exchange plate includes
   a second refrigerant input portion (211) that allows the refrigerant to enter the second refrigerant layer,
   a second refrigerant output portion (212) that allows the refrigerant to exit from the second refrigerant layer,
   a second coolant input portion (221) that allows the coolant to enter the second coolant layer, and
   a second coolant output portion (222) that allows the coolant to exit from the second coolant layer, and
a refrigerant circuit is formed in which when the first temperature of the first battery pack and the second battery pack is lower than the first threshold temperature, the refrigerant enters the first refrigerant input portion, exits from the first refrigerant output portion through the first refrigerant layer, enters the second refrigerant input portion, and exits from the second refrigerant output portion through the second refrigerant layer.

Accordingly, the second refrigerant layer functions as an evaporator.

### <Technique 7>

The vehicle control method according to the technique 6, in which
in the refrigerant circuit, an expansion valve (32) is disposed between the first refrigerant output portion and the second refrigerant input portion.

Accordingly, the second refrigerant layer functions as an evaporator.

### <Technique 8>

The vehicle control method according to the technique 6 or 7, in which
a coolant circuit is formed in which when the first temperature of the first battery pack is higher than the second threshold temperature higher than the first threshold temperature, the coolant enters the first coolant input portion, exits from the first coolant output portion through the first coolant layer, enters the second coolant input portion, and exits from the second coolant output portion through the second coolant layer.

In this way, the coolant is circulated through the first coolant layer and the second coolant layer in this order during the charging of the first battery pack, so that the heat obtained from the first battery pack during the charging when the coolant moves through the first coolant layer can be used in the second coolant layer to heat the second battery pack. Accordingly, the second battery pack can be efficiently heated.

### <Technique 9>

The vehicle control method according to any one of the techniques 1 to 8, in which
the first heat exchange plate is disposed along the predetermined direction, and
the second heat exchange plate is disposed along the predetermined direction.

Accordingly, the first heat exchange plate and the second heat exchange plate are disposed along the same predetermined direction (for example, the front-rear direction of the vehicle 1).

### <Technique 10>

The vehicle control method according to any one of the techniques 1 to 8, in which
the first heat exchange plate is disposed along a direction orthogonal to the predetermined direction,
the second heat exchange plate is disposed along the direction orthogonal to the predetermined direction, and
the orthogonal direction is a horizontal direction.

Accordingly, the first heat exchange plate and the second heat exchange plate are disposed along the direction orthogonal to the same predetermined direction (for example, the width direction of the vehicle 1).

### <Technique 11>

The second embodiment provides a vehicle control device (for example, the control device 10) set to be mounted in a vehicle (1), in which
the vehicle (1) includes
   a vehicle body (2),
   a first wheel (3a) and a second wheel (3b) coupled to the vehicle body,
   a first battery pack (11) disposed along a first surface in the vehicle body,
   a second battery pack (12) disposed along a second surface in the vehicle body,
   a first heat exchange plate (100) disposed along the first surface in the vehicle body,
   a second heat exchange plate (200) disposed along the second surface in the vehicle body, and
   an electric motor (4) that drives at least the first wheel using electric power supplied from the first battery pack and/or the second battery pack,
the vehicle (1) is movable by the first wheel and the second wheel in a predetermined direction,
the first heat exchange plate includes
   a third surface (103) disposed along the first surface and capable of exchanging heat with the first battery pack,
   a fourth surface (104) disposed along the first surface and opposite to the third surface,
   a first refrigerant layer (110) in which a refrigerant circulates between the third surface and the fourth surface, and
   a first coolant layer (120) in which a coolant circulates between the third surface and the fourth surface,
the second heat exchange plate includes
   a fifth surface (205) disposed along the second surface and capable of exchanging heat with the second battery pack,
   a sixth surface (206) disposed along the second surface and opposite to the fifth surface,
   a second refrigerant layer (210) in which the refrigerant circulates between the fifth surface and the sixth surface, and
   a second coolant layer (220) in which the coolant circulates between the fifth surface and the sixth surface,
when a first temperature of the first battery pack and the second battery pack is lower than a first threshold temperature, the refrigerant is circulated through the first refrigerant layer and the second refrigerant layer in this order, and a second temperature of the refrigerant entering the first refrigerant layer is higher than the first temperature of the first battery pack, and
when a third temperature of the first battery pack is higher than a second threshold temperature higher than the first threshold temperature, the first battery pack is charged, and the coolant is circulated through the first coolant layer and the second coolant layer in this order.

Accordingly, first, the first battery pack is heated to a temperature appropriate for charging by the first heat exchange plate, and then the coolant is circulated through the first coolant layer and the second coolant layer in this order during the charging of the first battery pack, so that heat obtained from the first battery pack during the charging when the coolant moves through the first coolant layer can be used in the second coolant layer to heat the second battery pack. Accordingly, the first battery pack and the second battery pack can be efficiently heated.

### <Technique 12>

The vehicle control device according to the technique 11, in which when the first temperature of the first battery pack and the second battery pack is lower than the first threshold temperature, the refrigerant is circulated through the first refrigerant layer and the second refrigerant layer in this order, and the coolant is circulated through the first coolant layer of the first heat exchange plate.

Accordingly, the first heat exchange plate can substantially uniformly heat the first battery pack to the temperature appropriate for the charging.

### <Technique 13>

The vehicle control device according to the technique 11 or 12, in which
when the third temperature of the first battery pack is higher than the second threshold temperature, the first battery pack is charged, and the coolant is circulated through the first coolant layer and the second coolant layer in this order, and
when a fourth temperature of the second battery pack is higher than a third threshold temperature higher than the first threshold temperature, the second battery pack is charged.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 14>

The vehicle control device according to any one of the techniques 11 to 13, in which
when the third temperature of the first battery pack is higher than the second threshold temperature, the first battery pack is charged, and
the coolant is circulated through the first coolant layer and the second coolant layer in this order, the refrigerant is circulated through the second refrigerant layer and the first refrigerant layer in this order, and a sixth temperature of the refrigerant entering the second refrigerant layer is higher than a seventh temperature of the second battery pack.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 15>

The vehicle control device according to the technique 14, in which
when the third temperature of the first battery pack is higher than the second threshold temperature, the first battery pack is charged, the coolant is circulated through the first coolant layer and the second coolant layer in this order, the refrigerant is circulated through the second refrigerant layer and the first refrigerant layer in this order, and the sixth temperature of the refrigerant entering the second refrigerant layer is higher than the seventh temperature of the second battery pack, and
when an eighth temperature of the second battery pack is higher than the third threshold temperature higher than the first threshold temperature, the second battery pack is charged.

Accordingly, since the heat obtained from the first battery pack during the charging when the coolant moves through the first coolant layer can be used in the second coolant layer to heat the second battery pack, the second heat exchange plate can efficiently and substantially uniformly heat the second battery pack to the temperature appropriate for charging.

### <Technique 16>

The vehicle control device according to any one of the techniques 11 to 15, in which
the first heat exchange plate includes
   a first refrigerant input portion (111) that allows the refrigerant to enter the first refrigerant layer,
   a first refrigerant output portion (112) that allows the refrigerant to exit from the first refrigerant layer,
   a first coolant input portion (121) that allows the coolant to enter the first coolant layer, and
   a first coolant output portion (122) that allows the coolant to exit from the first coolant layer,
the second heat exchange plate includes
   a second refrigerant input portion (211) that allows the refrigerant to enter the second refrigerant layer,
   a second refrigerant output portion (212) that allows the refrigerant to exit from the second refrigerant layer,
   a second coolant input portion (221) that allows the coolant to enter the second coolant layer, and
   a second coolant output portion (222) that allows the coolant to exit from the second coolant layer, and
a refrigerant circuit is formed in which when the first temperature of the first battery pack and the second battery pack is lower than the first threshold temperature, the refrigerant enters the first refrigerant input portion, exits from the first refrigerant output portion through the first refrigerant layer, enters the second refrigerant input portion, and exits from the second refrigerant output portion through the second refrigerant layer.

Accordingly, the second refrigerant layer functions as an evaporator.

### <Technique 17>

The vehicle control device according to the technique 16, in which in the refrigerant circuit, an expansion valve (32) is disposed between the first refrigerant output portion and the second refrigerant input portion.

Accordingly, the second refrigerant layer functions as an evaporator.

### <Technique 18>

The vehicle control device according to the technique 16 or 17, in which
a coolant circuit is formed in which when the first temperature of the first battery pack is higher than the second threshold temperature higher than the first threshold temperature, the coolant enters the first coolant input portion, exits from the first coolant output portion through the first coolant layer, enters the second coolant input portion, and exits from the second coolant output portion through the second coolant layer.

In this way, the coolant is circulated through the first coolant layer and the second coolant layer in this order during the charging of the first battery pack, so that the heat obtained from the first battery pack during the charging when the coolant moves through the first coolant layer can be used in the second coolant layer to heat the second battery pack. Accordingly, the second battery pack can be efficiently heated.

### <Technique 19>

The vehicle control device according to any one of the techniques 11 to 18, in which the first heat exchange plate is disposed along the predetermined direction, and the second heat exchange plate is disposed along the predetermined direction.

Accordingly, the first heat exchange plate and the second heat exchange plate are disposed along the same predetermined direction (for example, the front-rear direction of the vehicle 1).

### <Technique 20>

The vehicle control device according to any one of the techniques 11 to 18, in which
the first heat exchange plate is disposed along a direction orthogonal to the predetermined direction,
the second heat exchange plate is disposed along the direction orthogonal to the predetermined direction, and
the orthogonal direction is a horizontal direction.

Accordingly, the first heat exchange plate and the second heat exchange plate are disposed along the direction orthogonal to the same predetermined direction (for example, the width direction of the vehicle 1).

### (Third Embodiment) <Arrangement of Battery Packs>

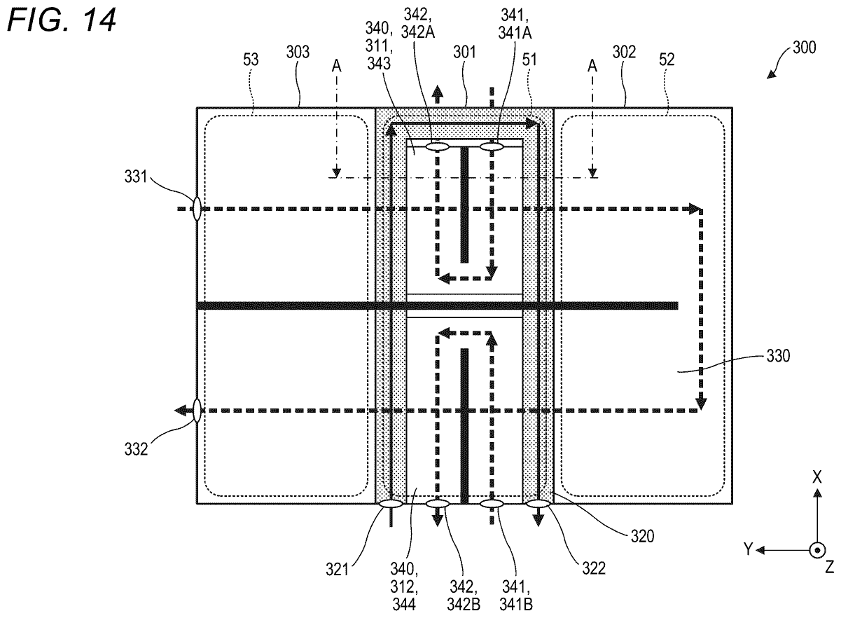

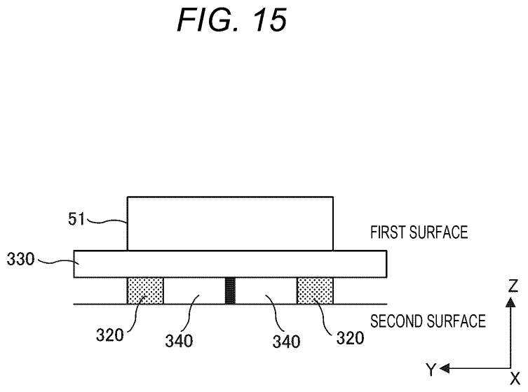

FIG. 14 is a schematic diagram showing a configuration of a heat exchange plate 300 and an arrangement example of battery packs according to a third embodiment. FIG. 15 is a schematic diagram showing a cross section taken along a line A-A of the heat exchange plate 300 shown in FIG. 14.

The heat exchange plate 300 includes a first surface and a second surface opposite to the first surface. The second surface may have some irregularities. A third battery pack 53, a first battery pack 51, and a second battery pack 52 are arranged side by side along the first surface of the heat exchange plate 300 so as not to be in contact with one another. In the present embodiment, the first battery pack 51 is disposed between the third battery pack 53 and the second battery pack 52.

The first surface of the heat exchange plate 300 includes, in a plan view, a third region 303 corresponding to the third battery pack 53, a first region 301 corresponding to the first battery pack 51, and a second region 302 corresponding to the second battery pack 52. That is, at least a part of the first region 301 is disposed between the second region 302 and the third region 303.

The heat exchange plate 300 includes a refrigerant passage 320 which is disposed corresponding to the first region 301 between the first surface and the second surface, and through which a refrigerant circulates. However, the refrigerant passage 320 may be disposed corresponding to at least a part of the second region 302 and/or the third region 303 in addition to the first region 301.

The heat exchange plate 300 includes a first coolant passage 330 which is disposed corresponding to the third region 303, the first region 301, and the second region 302 between the first surface and the second surface and through which a first coolant circulates. The heat exchange plate 300 includes a second coolant passage 340 which is disposed corresponding to the first region 301 between the first surface and the second surface and through which a second coolant circulates.

As shown in FIG. 15, in the first region 301, the refrigerant passage 320 and the first coolant passage 330 are disposed to overlap with each other in a plan view, and the first coolant passage 330 is disposed closer to the first surface than the refrigerant passage 320.

As shown in FIG. 14, the second coolant passage 340 includes a first portion 343 and a second portion 344, the first portion 343 of the second coolant passage 340 corresponds to a first portion 311 of the first region 301, and the second portion 344 of the second coolant passage 340 corresponds to a second portion 312 of the first region 301.

As shown in FIG. 14, the refrigerant passage 320 and the second coolant passage 340 are arranged side by side in a second direction (for example, the Y direction) intersecting a first direction (for example, the Z direction) from the first surface toward the second surface. The refrigerant passage 320 and the second coolant passage 340 may be in contact with each other or may have a slight gap therebetween in the second direction.

### <First Heating Mode>

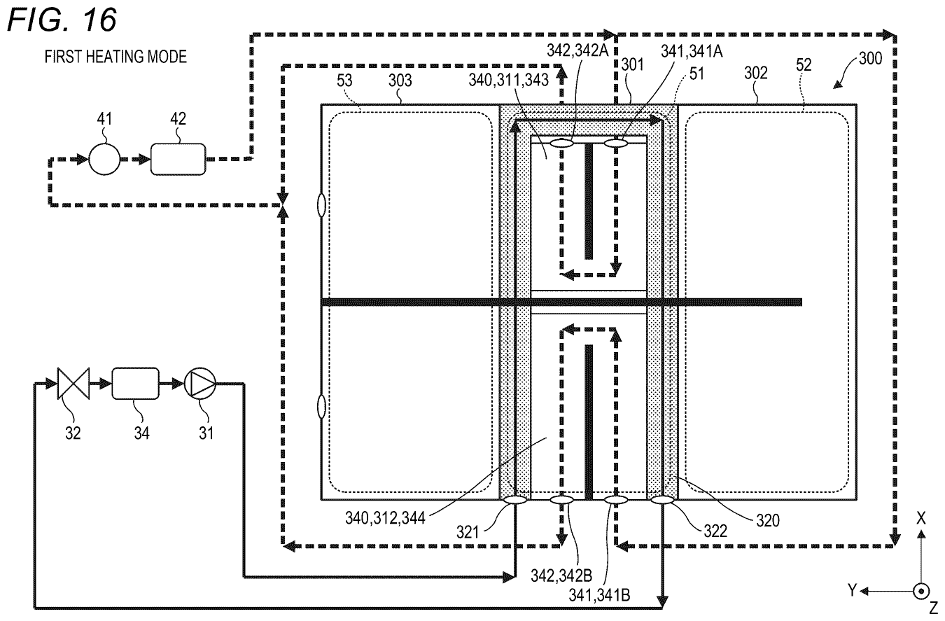

FIG. 16 is a schematic diagram showing an example of a refrigerant circuit and coolant circuits in a first heating mode according to the third embodiment.

The first heating mode is performed when at least a first temperature of the first battery pack 51 is lower than a first threshold temperature. The first threshold temperature corresponds to a lower limit of a temperature suitable for efficient charging of a secondary battery, and is, for example, 5° C. However, the first threshold temperature may be lower than 5° C. or higher than 5° C. A temperature of the first battery pack 51 may be measured by a temperature sensor (not shown) attached to the first battery pack 51. Temperatures of the second battery pack 52 and the third battery pack 53 may be measured by temperature sensors (not shown) attached to the second battery pack 52 and the third battery pack 53.

In the first heating mode, the refrigerant is circulated through the refrigerant passage 320 corresponding to the first region 301. In the first heating mode, a second temperature of the refrigerant entering the refrigerant passage 320 is higher than the first temperature of the first battery pack 51. Specifically, as shown in FIG. 16, the control device 10 forms the refrigerant circuit that allows the refrigerant to circulate through the compressor 31 that compresses the refrigerant, a first refrigerant input portion 321, the refrigerant passage 320 corresponding to the first region 301, a first refrigerant output portion 322, the expansion valve 32 that expands the refrigerant, and an evaporator 34 that can exchange heat with air outside the vehicle in this order as the first heating mode. For example, when the refrigerant at 80° C. enters the first refrigerant input portion 321 and moves through the refrigerant passage 320 corresponding to the first region 301, the refrigerant exchanges heat with the second coolant moving through the second coolant passage 340 corresponding to the first region 301 and the first battery pack 51 corresponding to the first region 301, and for example, the refrigerant at 50° C. exits from the first refrigerant output portion 322.

In addition, in the first heating mode, the second coolant is circulated through the second coolant passage 340 corresponding to the first region 301. Specifically, as shown in FIG. 16, the control device 10 forms a coolant circuit that allows the second coolant to circulate through the pump 41 that moves the second coolant, the heater 42 that heats the coolant, a second coolant input portion 341A, the first portion 343 of the second coolant passage 340, and a second coolant output portion 342A in this order, and a coolant circuit that allows the second coolant to circulate through the pump 41, the heater 42, a second coolant input portion 341B, the second portion 344 of the second coolant passage 340, and the second coolant output portion 342B in this order as the first heating mode. Here, the control device 10 may operate the heater 42 to heat the coolant. For example, when the second coolant at 40° C. enters the second coolant input portions 341A and 341B and moves through the second coolant passage 340, the second coolant exchanges heat with the refrigerant of the refrigerant passage 320 and the first battery pack 51 (that is, heats the first battery pack 51), and for example, the second coolant at 20° C. exits from the second coolant output portions 342A and 342B. The control device 10 may form the coolant circuits shown in FIG. 16 by controlling a three-way valve, a four-way valve, or the like (not shown).

The first heating mode may continue until the temperature of the first battery pack 51 becomes higher than a charge threshold temperature. The charge threshold temperature may be higher than the first threshold temperature (for example, 5° C.) or may be the same as the first threshold temperature. Accordingly, in the first heating mode, the first battery pack 51 is heated to a temperature higher than the charge threshold temperature. Charging of the first battery pack 51 may be started when the temperature becomes higher than the charge threshold temperature.

As described above, in the first heating mode, the first battery pack 51 disposed in the first region 301 of the heat exchange plate 300 performs heat exchange with the first region 301 of which a temperature is made substantially uniform by the second coolant flowing through the second coolant passage 340, and thus is heated with less temperature variation. Therefore, first, the temperature of the first battery pack 51 can be efficiently made higher than the charge threshold temperature.

In the first heating mode, the coolant may be circulated through the first coolant passage 330 at a first flow rate smaller than a second flow rate of the second coolant passage 340. However, the first flow rate may be zero. That is, in the first heating mode, there may be little or no coolant flowing through the first coolant passage 330.

### <Second Heating Mode>

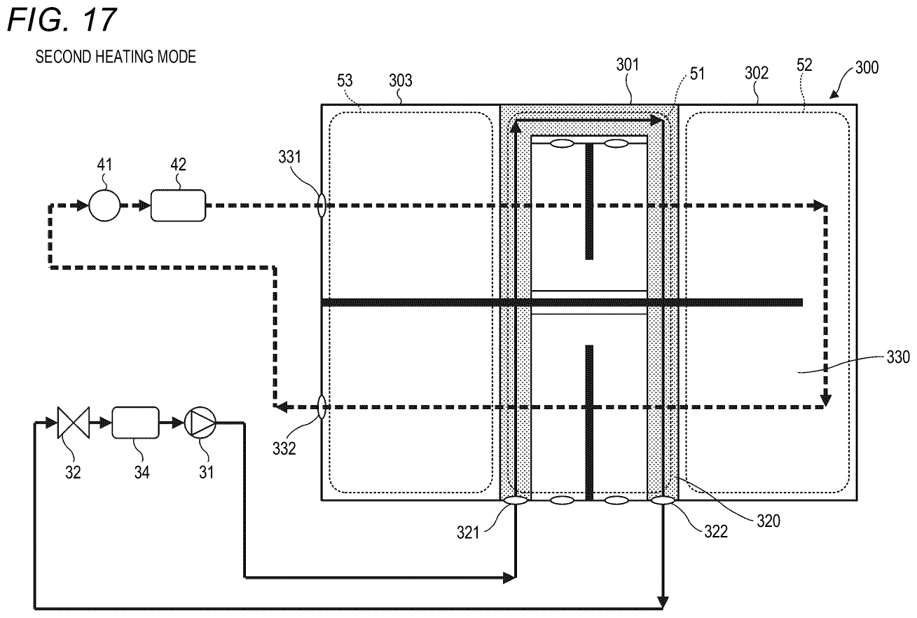

FIG. 17 is a schematic diagram showing an example of a refrigerant circuit and coolant circuits in a second heating mode according to the third embodiment.

The second heating mode is started when the temperature of the first battery pack 51 becomes higher than the charge threshold temperature in the first heating mode. As described above, the charge threshold temperature may be higher than the first threshold temperature (for example, 5° C.) or may be the same as the first threshold temperature.

In the second heating mode, the refrigerant is circulated through the refrigerant passage 320 corresponding to the first region 301 as in the first heating mode.

In addition, in the second heating mode, the first coolant is circulated through the first coolant passage 330. The first coolant and the second coolant may be the same. That is, when the first heating mode is switched to the second heating mode, the circulation of the coolant is switched from the second coolant passage 340 to the first coolant passage 330.

Specifically, as shown in FIG. 17, the control device 10 forms a coolant circuit that allows the first coolant to circulate through the pump 41, the heater 42, the first coolant input portion 331, the first coolant passage 330, and the first coolant output portion 332 in this order as the second heating mode. Here, the control device 10 may operate the heater 42 to heat the first coolant. For example, when the first coolant at 40° C. enters the first coolant input portion 331 and moves through the first coolant passage 330, the first coolant exchanges heat with the third battery pack 53 corresponding to the third region 303 (that is, heats the third battery pack 53), exchanges heat with the refrigerant corresponding to the first region 301 and the first battery pack 51, and exchanges heat with the second battery pack 52 corresponding to the second region 302 (that is, heats the second battery pack 52), and for example, the first coolant at 20° C. exits from the first coolant output portion 332. The control device 10 may form the first coolant passage shown in FIG. 17 by controlling a three-way valve, a four-way valve, or the like (not shown).

The second heating mode continues until the temperatures of the second battery pack 52 and the third battery pack 53 become higher than a charge threshold temperature. The charge threshold temperature in the second heating mode may be the same as or different from the charge threshold temperature in the first heating mode. Accordingly, in the second heating mode, the second battery pack 52 and the third battery pack 53 are heated to a temperature higher than the charge threshold temperature. Charging of the second battery pack 52 and the third battery pack 53 may be started when the temperatures become higher than the charge threshold temperature.

In the second heating mode, the first coolant obtains heat from the first battery pack 51 being charged while moving through the first coolant passage 330, and heats the third battery pack 53 and the second battery pack 52. Further, in the second heating mode, the first coolant is deprived of heat by the third battery pack 53 and the second battery pack 52 while moving through the first coolant passage 330, and cools the first battery pack 51 so that the temperature of the first battery pack 51 being charged does not rise excessively. As described above, in the second heating mode, the circulation of the first coolant can efficiently heat the third battery pack 53 and the second battery pack 52 and cool the first battery pack 51 being charged.

In the second heating mode, the coolant may be circulated in the second coolant passage 340 at the second flow rate smaller than the first flow rate in the first coolant passage 330. However, the second flow rate may be zero. That is, in the second heating mode, there may be little or no coolant flowing through the second coolant passage 340.

### <Cooling Mode>

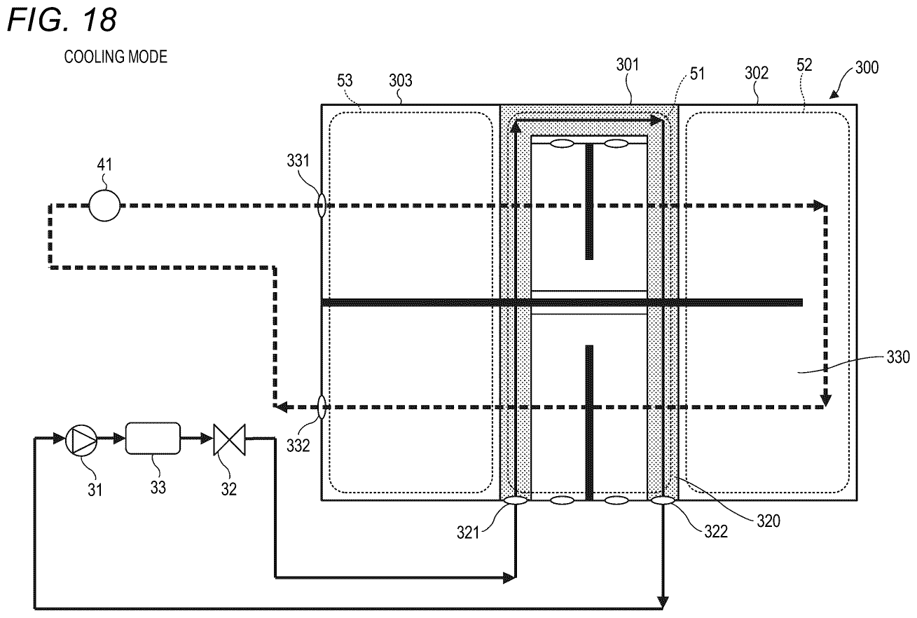

FIG. 18 is a schematic diagram showing an example of a refrigerant circuit and a coolant circuit in a cooling mode according to the third embodiment.

The cooling mode may be started when the temperature of at least one of the first battery pack 51, the second battery pack 52, and the third battery pack 53 becomes higher than the cooling threshold temperature. The cooling threshold temperature may be higher than the charge threshold temperature or may be the same as the charge threshold temperature. Further, a charge threshold temperature for the first battery pack 51, a charge threshold temperature for the second battery pack 52, and a charge threshold temperature for the third battery pack 53 may be the same or different. The charge threshold temperature corresponds to an upper limit of a temperature at which deterioration of the secondary battery can be prevented and charging and discharging can be stably performed, and may be, for example, 50° C. However, the charge threshold temperature may be lower than 50° C. or higher than 50° C. In the cooling mode, the first battery pack 51, the second battery pack 52, and the third battery pack 53 are cooled such that the temperatures of the first battery pack 51, the second battery pack 52, and the third battery pack 53 during charging and discharging do not rise excessively.

In the cooling mode, the refrigerant is circulated through the refrigerant passage 320 corresponding to the first region 301. In the cooling mode, the temperature of the refrigerant entering the refrigerant passage 320 is lower than the temperature of the first battery pack 51. Specifically, as shown in FIG. 18, the control device 10 forms the refrigerant circuit that allows the refrigerant to circulate through the compressor 31, the external condenser 33 capable of exchanging heat with the air outside the vehicle, the expansion valve 32, the first refrigerant input portion 321, the refrigerant passage 320, and the first refrigerant output portion 322 in this order as the cooling mode. For example, when the refrigerant at 0° C. enters the first refrigerant input portion 321 and moves through the refrigerant passage 320, the refrigerant exchanges heat with the first coolant moving in the first coolant passage 330, and for example, the refrigerant at 20° C. exits from the first refrigerant output portion 322. The control device 10 may form the refrigerant circuit shown in FIG. 18 by controlling a three-way valve, a four-way valve, or the like (not shown).

In addition, in the cooling mode, the first coolant is circulated through the first coolant passage 330 corresponding to the third region 303, the first region 301, and the second region 302. Specifically, as shown in FIG. 18, the control device 10 forms the coolant circuit that allows the first coolant to circulate through the pump 41, the first coolant input portion 331, the first coolant passage 330, and the first coolant output portion 332 in this order as the cooling mode. For example, when the first coolant enters the first coolant input portion 331 and moves through the first coolant passage 330, the first coolant exchanges heat with the refrigerant flowing through the third battery pack 53, the first battery pack 51, the second battery pack 52, and the refrigerant passage 320 (for example, cools the third battery pack 53, the first battery pack 51, and the second battery pack 52), and exits from the first coolant output portion 332. Accordingly, the third battery pack 53, the first battery pack 51, and the second battery pack 52 can be cooled substantially uniformly, and the third battery pack 53, the first battery pack 51, and the second battery pack 52 can be prevented from becoming too hot.

### (Summary of Third Embodiment)

The following techniques are disclosed from the above description of the third embodiment.

### <Technique 1>

The third embodiment provides a vehicle control method executable in a vehicle (1), in which
the vehicle (1) includes
   a vehicle body (2),
   a first wheel (3a) and a second wheel (3b) coupled to the vehicle body,
   a first battery pack (51) and a second battery pack (52) disposed along a predetermined surface in the vehicle body,
   a heat exchange plate (300) disposed along the predetermined surface in the vehicle body, and
   an electric motor (4) that drives at least the first wheel using electric power supplied from the first battery pack and/or the second battery pack,
the vehicle (1) is movable by the first wheel and the second wheel in a predetermined direction,
the heat exchange plate includes
a first surface disposed along the predetermined surface and capable of exchanging heat with the first battery pack and the second battery pack,
a second surface disposed along the predetermined surface and opposite to the first surface,
a first region (301) corresponding to the first battery pack in a plan view,
a second region (302) corresponding to the second battery pack in the plan view,
a refrigerant passage (320) which is disposed corresponding to the first region between the first surface and the second surface and through which a refrigerant circulates, and
a coolant passage (330) which is disposed corresponding to the first region and the second region between the first surface and the second surface and through which a coolant circulates, and
the vehicle control method includes:
   when at least a first temperature of the first battery pack is lower than a first threshold temperature, causing the refrigerant to circulate through the refrigerant passage corresponding to the first region, a second temperature of the refrigerant entering the refrigerant passage being higher than the first temperature of the first battery pack; and
   when a third temperature of the first battery pack is higher than a second threshold temperature higher than the first threshold temperature, charging the first battery pack, and causing the coolant to circulate through the coolant passage corresponding to the first region and the second region.

As a result, first, the first battery pack corresponding to the first region is heated to a temperature appropriate for charging, and then the coolant is circulated through the first region and the second region in this order during the charging of the first battery pack, so that heat obtained from the first battery pack being charged when the coolant moves through a portion corresponding to the first region can be used for heating the second battery pack corresponding to the second region. Accordingly, the first battery pack and the second battery pack can be efficiently heated.

### <Technique 2>

The vehicle control method according to the technique 1, in which
the vehicle further includes a third battery pack (53),
the first surface of the heat exchange plate is further capable of exchanging heat with the third battery pack,
the heat exchange plate includes a third region (303) corresponding to the third battery pack in the plan view,
at least a part of the first region is disposed between the second region and the third region, and
the coolant passage (330) which is disposed corresponding to the first region and the second region between the first surface and the second surface and through which the coolant circulates is further disposed corresponding to the third region, and allows the coolant to circulate.

Accordingly, the heat obtained from the first battery pack being charged when the coolant moves through the portion corresponding to the first region can be used for heating the second battery pack corresponding to the second region and the third battery pack corresponding to the third region. Accordingly, the first battery pack, the second battery pack, and the third battery pack can be efficiently heated.

### <Technique 3>

The vehicle control method according to the technique 1 or 2, further including:
when the first temperature of the first battery pack and the second battery pack is lower than the first threshold temperature, causing the refrigerant to circulate through the refrigerant passage corresponding to the first region;
when the third temperature of the first battery pack is higher than the second threshold temperature, charging the first battery pack, and causing the coolant to circulate through the coolant passage (330) corresponding to the first region and the second region; and
when a fourth temperature of the second battery pack is higher than a third threshold temperature higher than the first threshold temperature, charging the second battery pack.

Accordingly, the heat obtained from the first battery pack being charged when the coolant moves through the portion corresponding to the first region can be used for heating the second battery pack corresponding to the second region. Accordingly, the first battery pack and the second battery pack can be efficiently heated.

### <Technique 4>

The vehicle control method according to the technique 3, further including:
when the first temperature of the first battery pack and the second battery pack is lower than the first threshold temperature, causing the refrigerant to circulate through the refrigerant passage corresponding to the first region;
when the third temperature of the first battery pack is higher than the second threshold temperature, charging the first battery pack, and causing the coolant to circulate through the coolant passage (330) corresponding to the first region and the second region;
when the fourth temperature of the second battery pack is higher than the third threshold temperature higher than the first threshold temperature, charging the second battery pack; and
when a fifth temperature of the first battery pack is higher than a fourth threshold temperature higher than the second threshold temperature, causing the refrigerant to circulate through the refrigerant passage corresponding to the first region, a sixth temperature of the refrigerant entering the refrigerant passage being lower than the fifth temperature of the first battery pack, and causing the coolant to circulate through the coolant passage corresponding to the first region and the second region.

Accordingly, the first region of the heat exchange plate can substantially uniformly cool the first battery pack.

### <Technique 5>

The vehicle control method according to any one of the techniques 1 to 4, in which
the refrigerant passage and the coolant passage are disposed to overlap with each other in the first region of the heat exchange plate, and
the coolant passage is disposed closer to the first surface than the refrigerant passage.

Accordingly, the first region of the heat exchange plate can substantially uniformly cool the first battery pack.

### <Technique 6>

The vehicle control method according to any one of the techniques 1 to 5, in which
the coolant passage is a first coolant passage (330),
the coolant is a first coolant,
the heat exchange plate further includes a second coolant passage (340) which is disposed corresponding to the first region and through which a second coolant circulates,
when the first temperature of the first battery pack and the second battery pack is lower than the first threshold temperature, the refrigerant is circulated through the refrigerant passage corresponding to the first region, and the second coolant is circulated through the second coolant passage, and
when the third temperature of the first battery pack is higher than the second threshold temperature, the first battery pack is charged, and the first coolant is circulated through the first coolant passage corresponding to the first region and the second region.

Accordingly, the heat obtained from the first battery pack being charged when the coolant moves through the portion corresponding to the first region can be used for heating the second battery pack corresponding to the second region. Accordingly, the first battery pack and the second battery pack can be efficiently heated.

### <Technique 7>

The vehicle control method according to the technique 6, in which
the second coolant passage (340) of the heat exchange plate includes a first portion (343) and a second portion (344),
the first portion (343) of the second coolant passage corresponds to a first portion (311) of the first region (301), and
the second portion (344) of the second coolant passage is disposed corresponding to a second portion (312) of the first region (301).

Accordingly, the first region of the heat exchange plate can substantially uniformly heat the first battery pack.

### <Technique 8>

The vehicle control method according to the technique 6 or 7, in which
the first coolant passage (330), the refrigerant passage (320), and the second coolant passage (340) are disposed between the first surface and the second surface, and
the refrigerant passage and the second coolant passage are arranged side by side in a direction intersecting a direction from the first surface toward the second surface.

Accordingly, the refrigerant passage corresponding to the first region and the second coolant passage can be disposed.

### <Technique 9>

The vehicle control method according to any one of the techniques 6 to 8, in which
the first coolant circulating through the first coolant passage and the second coolant circulating through the second coolant passage are the same.

Accordingly, the first battery pack and the second battery pack can be substantially uniformly heated to a temperature appropriate for charging, and the first battery pack and the second battery pack which are being charged can be substantially uniformly cooled.

### <Technique 10>

The vehicle control method according to any one of the techniques 1 to 9, in which
the refrigerant passage of the heat exchange plate is connected to a refrigerant circuit,
the coolant passage of the heat exchange plate is connected to a coolant circuit,
the refrigerant circuit includes at least a compressor (for example, the compressor 31), and
the coolant circuit includes at least a pump (41).

Accordingly, the first battery pack and the second battery pack can be substantially uniformly heated to a temperature appropriate for charging, and the first battery pack and the second battery pack which are being charged can be substantially uniformly cooled.

### <Technique 11>

The third embodiment provides a vehicle control device (for example, the control device 10) set to be mounted in a vehicle (1), in which
the vehicle (1) includes
   a vehicle body (2),
   a first wheel (3a) and a second wheel (3b) coupled to the vehicle body,
   a first battery pack (51) and a second battery pack (52) disposed along a predetermined surface in the vehicle body,
   a heat exchange plate (300) disposed along the predetermined surface in the vehicle body, and
   an electric motor (4) that drives at least the first wheel using electric power supplied from the first battery pack and/or the second battery pack,
the vehicle (1) is movable by the first wheel and the second wheel in a predetermined direction,
the heat exchange plate includes
   a first surface disposed along the predetermined surface and capable of exchanging heat with the first battery pack and the second battery pack,
   a second surface disposed along the predetermined surface and opposite to the first surface,
   a first region (301) corresponding to the first battery pack in a plan view,
   a second region (302) corresponding to the second battery pack,
   a refrigerant passage (320) which is disposed corresponding to the first region between the first surface and the second surface and through which a refrigerant circulates, and
   a coolant passage (330) which is disposed corresponding to the first region and the second region between the first surface and the second surface and through which a coolant circulates,
when at least a first temperature of the first battery pack is lower than a first threshold temperature, the refrigerant is circulated through the refrigerant passage corresponding to the first region, and a second temperature of the refrigerant entering the refrigerant passage is higher than the first temperature of the first battery pack, and
when a third temperature of the first battery pack is higher than a second threshold temperature higher than the first threshold temperature, the first battery pack is charged, and the coolant is circulated through the coolant passage corresponding to the first region and the second region.

As a result, first, the first battery pack corresponding to the first region is heated to a temperature appropriate for charging, and then the coolant is circulated through the first region and the second region in this order during the charging of the first battery pack, so that heat obtained from the first battery pack being charged when the coolant moves through a portion corresponding to the first region can be used for heating the second battery pack corresponding to the second region. Accordingly, the first battery pack and the second battery pack can be efficiently heated.

### <Technique 12>

The vehicle control device according to the technique 11, in which
the vehicle further includes a third battery pack (53),
the first surface of the heat exchange plate is further capable of exchanging heat with the third battery pack,
the heat exchange plate includes a third region (303) corresponding to the third battery pack in the plan view,
at least a part of the first region is disposed between the second region and the third region, and
the coolant passage (330) which is disposed corresponding to the first region and the second region between the first surface and the second surface and through which the coolant circulates is further disposed corresponding to the third region, and allows the coolant to circulate.

Accordingly, the heat obtained from the first battery pack being charged when the coolant moves through the portion corresponding to the first region can be used for heating the second battery pack corresponding to the second region and the third battery pack corresponding to the third region. Accordingly, the first battery pack, the second battery pack, and the third battery pack can be efficiently heated.

### <Technique 13>

The vehicle control device according to the technique 11 or 12, in which
when the first temperature of the first battery pack and the second battery pack is lower than the first threshold temperature, the refrigerant is circulated through the refrigerant passage corresponding to the first region,
when the third temperature of the first battery pack is higher than the second threshold temperature, the first battery pack is charged, and the coolant is circulated through the coolant passage (330) corresponding to the first region and the second region, and
when a fourth temperature of the second battery pack is higher than a third threshold temperature higher than the first threshold temperature, the second battery pack is charged.

Accordingly, the heat obtained from the first battery pack being charged when the coolant moves through the portion corresponding to the first region can be used for heating the second battery pack corresponding to the second region. Accordingly, the first battery pack and the second battery pack can be efficiently heated.

### <Technique 14>

The vehicle control device according to the technique 13, in which
when the first temperature of the first battery pack and the second battery pack is lower than the first threshold temperature, the refrigerant is circulated through the refrigerant passage corresponding to the first region,
when the third temperature of the first battery pack is higher than the second threshold temperature, the first battery pack is charged, and the coolant is circulated through the coolant passage (330) corresponding to the first region and the second region,
when the fourth temperature of the second battery pack is higher than the third threshold temperature higher than the first threshold temperature, the second battery pack is charged, and
when a fifth temperature of the first battery pack is higher than a fourth threshold temperature higher than the second threshold temperature, the refrigerant is circulated through the refrigerant passage corresponding to the first region, a sixth temperature of the refrigerant entering the refrigerant passage is lower than the fifth temperature of the first battery pack, and the coolant is circulated through the coolant passage corresponding to the first region and the second region.

Accordingly, the first region of the heat exchange plate can substantially uniformly cool the first battery pack.

### <Technique 15>

The vehicle control device according to any one of the techniques 11 to 14, in which
the refrigerant passage and the coolant passage are disposed to overlap with each other in the first region of the heat exchange plate, and
the coolant passage is disposed closer to the first surface than the refrigerant passage.

Accordingly, the first region of the heat exchange plate can substantially uniformly cool the first battery pack.

### <Technique 16>

The vehicle control device according to any one of the techniques 11 to 15, in which
the coolant passage is a first coolant passage (330),
the coolant is a first coolant,
the heat exchange plate further includes a second coolant passage (340) which is disposed corresponding to the first region and through which a second coolant circulates,
when the first temperature of the first battery pack and the second battery pack is lower than the first threshold temperature, the refrigerant is circulated through the refrigerant passage corresponding to the first region, and the second coolant is circulated through the second coolant passage, and
when the third temperature of the first battery pack is higher than the second threshold temperature, the first battery pack is charged, and the first coolant is circulated through the first coolant passage corresponding to the first region and the second region.

Accordingly, the heat obtained from the first battery pack being charged when the coolant moves through the portion corresponding to the first region can be used for heating the second battery pack corresponding to the second region. Accordingly, the first battery pack and the second battery pack can be efficiently heated.

### <Technique 17>

The vehicle control device according to the technique 16, in which
the second coolant passage (340) of the heat exchange plate includes a first portion (343) and a second portion (344),
the first portion (343) of the second coolant passage corresponds to a first portion (311) of the first region (301), and
the second portion (344) of the second coolant passage is disposed corresponding to a second portion (312) of the first region (301).

Accordingly, the first region of the heat exchange plate can substantially uniformly heat the first battery pack.

### <Technique 18>

The vehicle control device according to the technique 16 or 17, in which
the first coolant passage (330), the refrigerant passage (320), and the second coolant passage (340) are disposed between the first surface and the second surface, and
the refrigerant passage and the second coolant passage are arranged side by side in a direction intersecting a direction from the first surface toward the second surface.

Accordingly, the refrigerant passage corresponding to the first region and the second coolant passage can be disposed.

### <Technique 19>

The vehicle control device according to any one of the techniques 16 to 18, in which
the first coolant circulating through the first coolant passage and the second coolant circulating through the second coolant passage are the same.

Accordingly, the first battery pack and the second battery pack can be substantially uniformly heated to a temperature appropriate for charging, and the first battery pack and the second battery pack which are being charged can be substantially uniformly cooled.

### <Technique 20>

The vehicle control device according to any one of the techniques 11 to 19, in which
the refrigerant passage of the heat exchange plate is connected to a refrigerant circuit,
the coolant passage of the heat exchange plate is connected to a coolant circuit,
the refrigerant circuit includes at least a compressor (for example, the compressor 31), and
the coolant circuit includes at least a pump (41).

Accordingly, the first battery pack and the second battery pack can be substantially uniformly heated to a temperature appropriate for charging, and the first battery pack and the second battery pack which are being charged can be substantially uniformly cooled.

### Fourth Embodiment

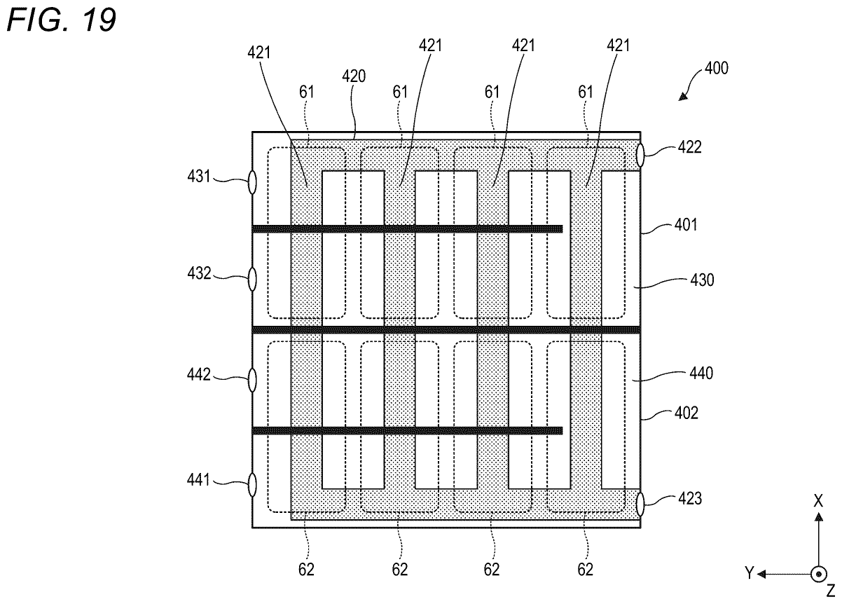

FIG. 19 is a schematic diagram showing a configuration of a heat exchange plate 400 and an arrangement example of battery packs according to a fourth embodiment.

The heat exchange plate 400 includes a first surface and a second surface opposite to the first surface. One or more first battery packs 61 are arranged side by side in a first direction (the Y direction in FIG. 19) along the first surface of the heat exchange plate 400. In addition, one or more second battery packs 62 are arranged side by side in the first direction (the Y direction in FIG. 19) along the first surface of the heat exchange plate 400. The first battery packs 61 and the second battery packs 62 may be arranged side by side in a second direction (the X direction in FIG. 19) orthogonal to the first direction.

The first surface of the heat exchange plate 400 includes, in a plan view, a first region 401 corresponding to the one or more first battery packs 61 and a second region 402 corresponding to the one or more second battery packs 62.

The heat exchange plate 400 includes, between the first surface and the second surface, a first coolant passage 430 which is disposed corresponding to the first region 401 and through which a first coolant circulates, and a second coolant passage 440 which is disposed corresponding to the second region 402 and through which a second coolant circulates.

The heat exchange plate 400 includes a refrigerant passage 420 which is disposed corresponding to the first region 401 and the second region 402 between the first surface and the second surface, and through which a refrigerant circulates. The refrigerant passage 420 may have, for example, a configuration including a plurality of branch refrigerant passages 421 as in FIG. 6. Further, the first battery packs 61 and the second battery packs 62 may be disposed on the branch refrigerant passages 421 disposed along the second direction (the X direction in FIG. 19) in a plan view.

### <First Heating Mode>

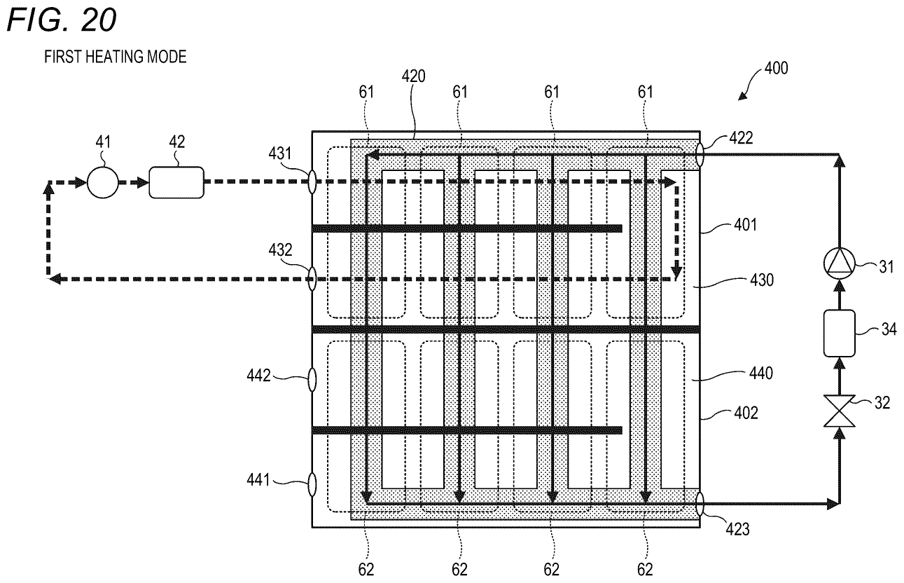

FIG. 20 is a schematic diagram showing an example of a refrigerant circuit and a coolant circuit in a first heating mode according to the fourth embodiment.

The first heating mode is performed when at least a first temperature of the first battery pack 61 is lower than a first threshold temperature. The first threshold temperature corresponds to a lower limit of a temperature suitable for efficient charging of a secondary battery, and is, for example, 5° C. However, the first threshold temperature may be lower than 5° C. or higher than 5° C. A temperature of the first battery pack 61 may be measured by a temperature sensor (not shown) attached to the first battery pack 61. A temperature of the second battery packs 62 may be measured by a temperature sensor (not shown) attached to the second battery packs 62.

In the first heating mode, the refrigerant is circulated such that the refrigerant is input from a first refrigerant input and output portion 422, passes through the refrigerant passage 420, and is output from a second refrigerant input and output portion 423. In the first heating mode, a second temperature of the refrigerant entering the first refrigerant input and output portion 422 is higher than the first temperature of the first battery packs 61. Specifically, as shown in FIG. 20, the control device 10 forms a refrigerant circuit that allows the refrigerant to circulate through the compressor 31 that compresses the refrigerant, the first refrigerant input and output portion 422, the refrigerant passage 420 including the branch refrigerant passages 421, the second refrigerant input and output portion 423, the expansion valve 32 that expands the refrigerant, and the evaporator 34 capable of exchanging heat with air outside the vehicle in this order as the first heating mode. For example, when the refrigerant at 80° C. enters the first refrigerant input and output portion 422 and moves through the refrigerant passage 420, the first coolant flowing through the first coolant passage 430 corresponding to the first region 401 exchanges heat with the first battery packs 61 and the second battery packs 62, and for example, the refrigerant at 50° C. exits from the second refrigerant input and output portion 623.

In addition, in the first heating mode, the first coolant is circulated through the first coolant passage 430 corresponding to the first region 401. Specifically, as shown in FIG. 20, the control device 10 forms a coolant circuit that allows the first coolant to circulate through the pump 41 that moves the first coolant, the heater 42 that heats the first coolant, a first coolant input portion 431, the first coolant passage 430, and a first coolant output portion 432 in this order as the first heating mode. Here, the control device 10 may operate the heater 42 to heat the first coolant. For example, when the first coolant at 40° C. enters the first coolant input portion 431 and moves through the first coolant passage 430, the first coolant exchanges heat with the refrigerant in the refrigerant passage 420 and the first battery packs 61 (that is, heats the first battery packs 61), and for example, the first coolant at 20° C. exits from the first coolant output portion 432. The control device 10 may form the coolant circuit shown in FIG. 20 by controlling a three-way valve, a four-way valve, or the like (not shown).

The first heating mode may continue until the temperature of the first battery packs 61 becomes higher than a charge threshold temperature. The charge threshold temperature may be higher than the first threshold temperature (for example, 5° C.) or may be the same as the first threshold temperature. Accordingly, in the first heating mode, the first battery packs 61 are heated to a temperature higher than the charge threshold temperature. Charging of the first battery packs 61 may be started when the temperature becomes higher than the charge threshold temperature.

As described above, in the first heating mode, the one or more first battery packs 61 disposed in the first region 401 of the heat exchange plate 400 exchange heat with the first region 401 of which a temperature is made substantially uniform by the first coolant moving through the first coolant passage 430, and thus are heated with less temperature variation. Accordingly, first, the temperature of the one or more first battery packs 61 can be efficiently made higher than the charge threshold temperature.

In the first heating mode, the coolant may be circulated in the second coolant passage 440 at a second flow rate smaller than the first flow rate in the first coolant passage 430. However, the second flow rate may be zero. That is, in the first heating mode, there may be little or no coolant flowing through the second coolant passage 440.

### <Second Heating Mode>

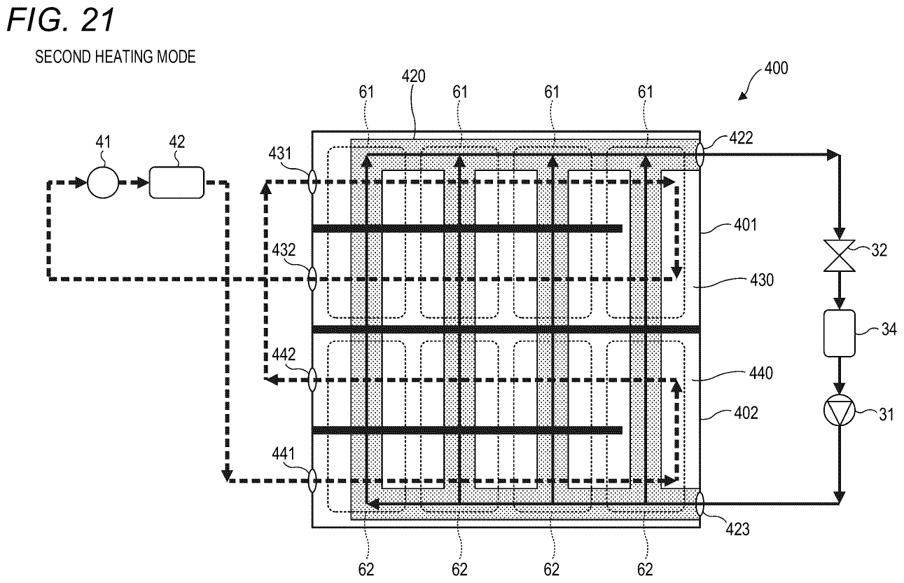

FIG. 21 is a schematic diagram showing an example of a refrigerant circuit and a coolant circuit in a second heating mode according to the fourth embodiment.

The second heating mode is started when the temperature of the first battery packs 61 become higher than the charge threshold temperature in the first heating mode. As described above, the charge threshold temperature may be higher than the first threshold temperature (for example, 5° C.) or may be the same as the first threshold temperature.

In the second heating mode, contrary to the first heating mode, the refrigerant is circulated by inputting from the second refrigerant input and output portion 423, passing through the refrigerant passage 420, and outputting from the first refrigerant input and output portion 422. In the second heating mode, a fourth temperature of the refrigerant entering the second refrigerant input and output portion 423 is higher than a fifth temperature of the second battery packs 62. Specifically, as shown in FIG. 21, the control device 10 forms a refrigerant circuit that allows the refrigerant to circulate through the compressor 31 that compresses the refrigerant, the second refrigerant input and output portion 423, the refrigerant passage 420 including the branch refrigerant passages 421, the first refrigerant input and output portion 422, the expansion valve 32 that expands the refrigerant, and the evaporator 34 capable of exchanging heat with air outside the vehicle in this order as the second heating mode. For example, when the refrigerant at 80° C. enters the second refrigerant input and output portion 423 and moves through the refrigerant passage 420, the refrigerant exchanges heat with the second coolant flowing through the second coolant passage 440 corresponding to the second region 402 and the first battery packs 61 and the second battery packs 62, and for example, the refrigerant at 50° C. exits from the first refrigerant input and output portion 422.

In addition, in the second heating mode, the first coolant is circulated through the first coolant passage 430 corresponding to the first region 401, and the second coolant is circulated through the second coolant passage 440 corresponding to the second region 402. The first coolant and the second coolant may be the same. Specifically, as shown in FIG. 21, the control device 10 forms the coolant circuit that allows the coolant to circulate through the pump 41, the heater 42, the second coolant input portion 441, the second coolant passage 440 corresponding to the second region 402, the second coolant output portion 442, the first coolant input portion 431, the first coolant passage 430 corresponding to the first region 401, and the first coolant output portion 432 in this order as the second heating mode. Here, the control device 10 may operate the heater 42 to heat the coolant. For example, when the coolant at 40° C. enters the second coolant input portion 441 and moves through the second coolant passage 440, the coolant exchanges heat with the refrigerant of the refrigerant passage 420 and the second battery packs 62 (that is, heats the second battery pack 62), for example, the coolant at 20° C. exits from the second coolant output portion 442. When the coolant enters the first coolant input portion 431 and moves through the first coolant passage 430, the coolant exchanges heat with the refrigerant of the refrigerant passage 420 and the first battery pack 61 (that is, cools the first battery pack 61), and for example, the coolant at 30° C. exits from the first coolant output portion 432. The control device 10 may form the coolant circuit shown in FIG. 21 by controlling a three-way valve, a four-way valve, or the like (not shown).

The second heating mode continues until the temperature of the second battery packs 62 becomes higher than the charge threshold temperature. The charge threshold temperature in the second heating mode may be the same as or different from the charge threshold temperature in the first heating mode. Accordingly, in the second heating mode, the one or more second battery packs 62 are heated to a temperature higher than the charge threshold temperature. Charging of the second battery packs 62 may be started when the temperature becomes higher than the charge threshold temperature.

In the second heating mode, the coolant obtains heat from the first battery pack 61 being charged while moving through the first coolant passage 430, and then enters the second coolant passage 440 to heat the second battery packs 62. Further, in the second heating mode, the coolant is deprived of heat by the second battery packs 62 while moving through the second coolant passage 440, and then enters the first coolant passage 430 to cool the first battery packs 61 so that the temperature of the first battery packs 61 being charged does not rise excessively. As described above, in the second heating mode, it is possible to efficiently heat the second battery packs 62 and cool the first battery packs 61 being charged by circulating the coolant.

In the first heating mode, since the refrigerant first enters the first refrigerant input and output portion 422 in a high temperature state, the first battery packs 61 corresponding to the first region 401 can be efficiently heated. Further, in the second heating mode, since the refrigerant first enters the second refrigerant input and output portion 423 in a high temperature state, the second battery packs 62 corresponding to the second region 402 are efficiently heated, and the refrigerant is moved toward the first battery packs 61 corresponding to the first region 401 after the heat is taken away by the second battery packs 62, and thus the first battery packs 61 being charged can be prevented from being heated.

### <Cooling Mode>

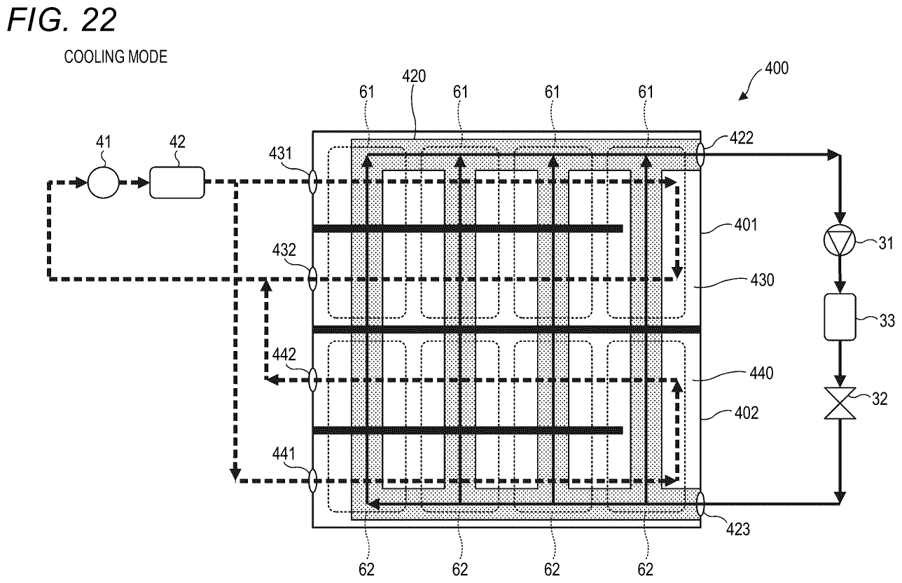

FIG. 22 is a schematic diagram showing an example of a refrigerant circuit and a coolant circuit in a cooling mode according to the fourth embodiment.

The cooling mode may be started when the temperature of the first battery packs 61 and/or the second battery packs 62 becomes higher than a cooling threshold temperature. The cooling threshold temperature may be higher than the charge threshold temperature or may be the same as the charge threshold temperature. Further, the charge threshold temperature for the first battery packs 61 and the charge threshold temperature for the second battery packs 62 may be the same or different. The charge threshold temperature corresponds to an upper limit of a temperature at which deterioration of the secondary battery can be prevented and charging and discharging can be stably performed, and may be, for example, 50° C. However, the charge threshold temperature may be lower than 50° C. or higher than 50° C. In the cooling mode, the first battery packs 61 and the second battery packs 62 are cooled so that the temperatures of the first battery packs 61 and the second battery packs 62 during charging and discharging do not rise excessively.

In the cooling mode, the refrigerant is circulated through the refrigerant passage 420 of the heat exchange plate 400. In the cooling mode, the temperature of the refrigerant entering the second refrigerant input and output portion 423 is lower than the temperature of the second battery packs 62. Specifically, as shown in FIG. 22, the control device 10 forms a refrigerant circuit that allows the refrigerant to circulate through the external condenser 33 capable of exchanging heat with the air outside the vehicle, the expansion valve 32, the second refrigerant input and output portion 423, the refrigerant passage 420 including the branch refrigerant passages 421, the first refrigerant input and output portion 422, and the compressor 31 in this order as the cooling mode. For example, when the refrigerant at 0° C. enters the second refrigerant input and output portion 423 and moves through the branch refrigerant passages 421, the refrigerant exchanges heat with the second coolant moving in the second coolant passage 440 and the first coolant moving in the first coolant passage 430, and for example, the refrigerant at 20° C. exits from the first refrigerant input and output portion 422. In the cooling mode, a refrigerant circuit may be formed in which the refrigerant enters from the first refrigerant input and output portion 422 and exits from the second refrigerant input and output portion 423. The control device 10 may form the refrigerant circuit shown in FIG. 22 by controlling a three-way valve, a four-way valve, or the like (not shown).

In addition, in the cooling mode, the first coolant is circulated through the first coolant passage 430, and the second coolant is circulated through the second coolant passage 440. Specifically, as shown in FIG. 22, the control device forms a coolant circuit that allows the first coolant to circulate through the pump 41, the first coolant input portion 431, the first coolant passage 430, and the first coolant output portion 432 in this order, and a coolant circuit that allows the second coolant to circulate through the pump 41, the second coolant input portion 441, the second coolant passage 440, and the second coolant output portion 442 in this order as the cooling mode. The first coolant and the second coolant may be the same. For example, when the first coolant enters the first coolant input portion 431 and moves through the first coolant passage 430, the first coolant exchanges heat with the refrigerant moving through the branch refrigerant passages 421 and the first battery packs 61 (for example, cools the first battery packs 61), and exits from the first coolant output portion 432. In addition, when the second coolant enters the second coolant input portion 441 and moves through the second coolant passage 440, the second coolant exchanges heat with the refrigerant moving through the branch refrigerant passages 421 and the second battery packs 62 (for example, cools the second battery packs 62), and exits from the second coolant output portion 442. In the cooling mode, as in the second heating mode, the coolant circuit may be formed in which the coolant circulates through the first coolant passage 430 and the second coolant passage 440 in this order. Accordingly, the one or more first battery packs 61 and the second battery packs 62 can be cooled substantially uniformly, and the first battery packs 61 and the second battery packs 62 can be prevented from becoming too hot.

### (Summary of Fourth Embodiment)

The following techniques are disclosed from the above description of the fourth embodiment.

### <Technique 1>

The fourth embodiment provides a vehicle control method executable in a vehicle, in which
the vehicle includes
   a vehicle body (2),
   a first wheel (3a) and a second wheel (3b) coupled to the vehicle body,
   a first battery pack (61) and a second battery pack (62) disposed along a predetermined surface in the vehicle body,
   a heat exchange plate (400) disposed along the predetermined surface in the vehicle body, and
   an electric motor (4) that drives at least the first wheel using electric power supplied from the first battery pack and/or the second battery pack,
the vehicle is movable by the first wheel and the second wheel in a predetermined direction,
the heat exchange plate includes
   a first surface disposed along the predetermined surface and capable of exchanging heat with the first battery pack and the second battery pack,
   a second surface disposed along the predetermined surface and opposite to the first surface,
   a first region (401) corresponding to the first battery pack in a plan view,
   a second region (402) corresponding to the second battery pack in the plan view,
   a first coolant passage (430) which is disposed corresponding to the first region between the first surface and the second surface and through which a first coolant circulates,
   a second coolant passage (440) which is disposed corresponding to the second region between the first surface and the second surface and through which a second coolant circulates,
   a refrigerant passage (420) which is disposed corresponding to the first region and the second region between the first surface and the second surface and through which a refrigerant circulates,
   a first refrigerant input and output portion (422) connected to the refrigerant passage in the first region, and
   a second refrigerant input and output portion (423) connected to the refrigerant passage in the second region, and
the vehicle control method includes:
   when at least a first temperature of the first battery pack is lower than a first threshold temperature, causing the refrigerant to circulate such that the refrigerant is input from the first refrigerant input and output portion, passes through the refrigerant passage, and is output from the second refrigerant input and output portion, a second temperature of the refrigerant entering the first refrigerant input and output portion being higher than the first temperature of the first battery pack, and causing the first coolant to circulate through the first coolant passage; and
   when a third temperature of the first battery pack is higher than a second threshold temperature higher than the first threshold temperature, charging the first battery pack, and causing the first coolant and the second coolant to circulate through the first coolant passage and the second coolant passage in this order.

Accordingly, first, the first battery pack corresponding to the first region is heated to a temperature appropriate for charging, and then the first coolant and the second coolant are circulated through the first coolant passage and the second coolant passage in this order during the charging of the first battery pack, so that heat obtained from the first battery pack being charged when the coolant moves through the first coolant passage corresponding to the first region can be used for heating the second battery pack when the coolant moves through the second coolant passage corresponding to the second region. Accordingly, the first battery pack and the second battery pack can be efficiently heated.

### <Technique 2>

The vehicle control method according to the technique 1, further including:
when at least the first temperature of the first battery pack is lower than the first threshold temperature, causing the refrigerant to circulate such that the refrigerant is input from the first refrigerant input and output portion, passes through the refrigerant passage, and is output from the second refrigerant input and output portion, and causing the first coolant to circulate through the first coolant passage;
when the third temperature of the first battery pack is higher than the second threshold temperature, charging the first battery pack, and causing the first coolant and the second coolant to circulate through the first coolant passage and the second coolant passage in this order; and
when a fifth temperature of the second battery pack is higher than a third threshold temperature higher than the first threshold temperature, charging the second battery pack.

Accordingly, the heat obtained from the first battery pack being charged when the coolant moves through the first coolant passage corresponding to the first region can be used for heating the second battery pack when the coolant moves through the second coolant passage corresponding to the second region. Accordingly, the first battery pack and the second battery pack can be efficiently heated.

### <Technique 3>

The vehicle control method according to the technique 1 or 2, further including:
when at least the first temperature of the first battery pack is lower than the first threshold temperature, causing the refrigerant to circulate such that the refrigerant is input from the first refrigerant input and output portion, passes through the refrigerant passage, and is output from the second refrigerant input and output portion, and causing the first coolant to circulate through the first coolant passage;
when the third temperature of the first battery pack is higher than the second threshold temperature, charging the first battery pack, causing the first coolant and the second coolant to circulate through the first coolant passage and the second coolant passage in this order, and causing the refrigerant to circulate such that the refrigerant is input from the second refrigerant input and output portion, passes through the refrigerant passage, and is output from the first refrigerant input and output portion, a fourth temperature of the refrigerant entering the second refrigerant input and output portion being higher than the fifth temperature of the second battery pack.

Accordingly, the second battery pack corresponding to the second region can be efficiently heated by the high-temperature refrigerant.

### <Technique 4>

The vehicle control method according to the technique 1 or 2, further including:
when at least the first temperature of the first battery pack is lower than the first threshold temperature, causing the refrigerant to circulate such that the refrigerant is input from the first refrigerant input and output portion, passes through the refrigerant passage, and is output from the second refrigerant input and output portion, and causing the first coolant to circulate through the first coolant passage;
when the third temperature of the first battery pack is higher than the second threshold temperature, charging the first battery pack, causing the first coolant and the second coolant to circulate through the first coolant passage and the second coolant passage in this order, and causing the refrigerant to circulate such that the refrigerant is input from the second refrigerant input and output portion, passes through the refrigerant passage, and is output from the first refrigerant input and output portion; and
when the fifth temperature of the second battery pack is higher than the third threshold temperature higher than the first threshold temperature, charging the second battery pack.

Accordingly, the second battery pack corresponding to the second region can be efficiently heated to a temperature appropriate for charging by the high-temperature refrigerant.

### <Technique 5>

The vehicle control method according to the technique 2 or 4, further including:
when a sixth temperature of the first battery pack is higher than a fourth threshold temperature higher than the second threshold temperature and/or when a seventh temperature of the second battery pack is higher than a fifth threshold temperature higher than the third threshold temperature,
causing the refrigerant to circulate such that the refrigerant is input from one of the first refrigerant input and output portion and the second refrigerant input and output portion, passes through the refrigerant passage, and is output from the other of the first refrigerant input and output portion and the second refrigerant input and output portion, an eighth temperature of the refrigerant entering the one of the first refrigerant input and output portion and the second refrigerant input and output portion being lower than the sixth temperature of the first battery pack and/or the seventh temperature of the second battery pack.

Accordingly, the heat exchange plate can substantially uniformly cool the first battery pack and the second battery pack.

### <Technique 6>

The vehicle control method according to the technique 5, further including:
when the sixth temperature of the first battery pack is higher than the fourth threshold temperature and/or when the seventh temperature of the second battery pack is higher than the fifth threshold temperature,
causing the refrigerant to circulate such that the refrigerant is input from the one of the first refrigerant input and output portion and the second refrigerant input and output portion, passes through the refrigerant passage, and is output from the other of the first refrigerant input and output portion and the second refrigerant input and output portion, the eighth temperature of the refrigerant entering the one of the first refrigerant input and output portion and the second refrigerant input and output portion being lower than a ninth temperature of the first coolant.

Accordingly, the heat exchange plate can substantially uniformly cool the first battery pack and the second battery pack.

### <Technique 7>

The vehicle control method according to the technique 5, further including:
when the sixth temperature of the first battery pack is higher than the fourth threshold temperature and/or when the seventh temperature of the second battery pack is higher than the fifth threshold temperature,
causing the refrigerant to circulate such that the refrigerant is input from the one of the first refrigerant input and output portion and the second refrigerant input and output portion, passes through the refrigerant passage, and is output from the other of the first refrigerant input and output portion and the second refrigerant input and output portion, and causing the first coolant and the second coolant to circulate through the first coolant passage and the second coolant passage in this order or through the second coolant passage and the first coolant passage in this order.

Accordingly, the heat exchange plate can substantially uniformly cool the first battery pack and the second battery pack.

### <Technique 8>

The vehicle control method according to the technique 5, further including:
when the sixth temperature of the first battery pack is higher than the fourth threshold temperature and/or when the seventh temperature of the second battery pack is higher than the fifth threshold temperature,
causing the refrigerant to circulate such that the refrigerant is input from the one of the first refrigerant input and output portion and the second refrigerant input and output portion, passes through the refrigerant passage, and is output from the other of the first refrigerant input and output portion and the second refrigerant input and output portion, causing the first coolant to circulate through the first coolant passage, and causing the second coolant to circulate through the second coolant passage.

Accordingly, the heat exchange plate can substantially uniformly cool the first battery pack and the second battery pack.

### <Technique 9>

The vehicle control method according to any one of the techniques 1 to 8, in which
the vehicle includes at least a pump (41) and a heater (42), and includes a coolant circuit capable of causing the first coolant and/or the second coolant to circulate, and
the first coolant passage is connected to the coolant circuit.

Accordingly, the first coolant and/or the second coolant can be heated by the heater.

### <Technique 10>

The vehicle control method according to any one of the techniques 1 to 9, in which
the vehicle includes at least a compressor (for example, the compressor 31), and includes a refrigerant circuit capable of causing the refrigerant to circulate, and
the first refrigerant input and output portion (422) and the second refrigerant input and output portion (423) are connected to the refrigerant circuit.

Accordingly, the first battery pack and the second battery pack can be substantially uniformly heated to a temperature appropriate for charging, and the first battery pack and the second battery pack which are being charged can be substantially uniformly cooled.

### <Technique 11>

The fourth embodiment provides a vehicle control device (for example, the control device 10) set to be mounted in a vehicle, in which
the vehicle includes
   a vehicle body (2),
   a first wheel (3a) and a second wheel (3b) coupled to the vehicle body,
   a first battery pack (61) and a second battery pack (62) disposed along a predetermined surface in the vehicle body,
   a heat exchange plate (400) disposed along the predetermined surface in the vehicle body, and
   an electric motor (4) that drives at least the first wheel using electric power supplied from the first battery pack and/or the second battery pack,
the vehicle is movable by the first wheel and the second wheel in a predetermined direction,
the heat exchange plate includes
   a first surface disposed along the predetermined surface and capable of exchanging heat with the first battery pack and the second battery pack,
   a second surface disposed along the predetermined surface and opposite to the first surface,
   a first region (401) corresponding to the first battery pack in a plan view,
   a second region (402) corresponding to the second battery pack in the plan view,
   a first coolant passage (430) which is disposed corresponding to the first region between the first surface and the second surface and through which a first coolant circulates,
   a second coolant passage (440) which is disposed corresponding to the second region between the first surface and the second surface and through which a second coolant circulates,
   a refrigerant passage (420) which is disposed corresponding to the first region and the second region between the first surface and the second surface and through which a refrigerant circulates,
   a first refrigerant input and output portion (422) connected to the refrigerant passage in the first region, and
   a second refrigerant input and output portion (423) connected to the refrigerant passage in the second region,
when at least a first temperature of the first battery pack is lower than a first threshold temperature, the refrigerant is circulated such that the refrigerant is input from the first refrigerant input and output portion, passes through the refrigerant passage, and is output from the second refrigerant input and output portion, a second temperature of the refrigerant entering the first refrigerant input and output portion is higher than the first temperature of the first battery pack, and the first coolant is circulated through the first coolant passage, and
when a third temperature of the first battery pack is higher than a second threshold temperature higher than the first threshold temperature, the first battery pack is charged, and the first coolant and the second coolant is circulated through the first coolant passage and the second coolant passage in this order.

Accordingly, first, the first battery pack corresponding to the first region is heated to a temperature appropriate for charging, and then the first coolant and the second coolant are circulated through the first coolant passage and the second coolant passage in this order during the charging of the first battery pack, so that heat obtained from the first battery pack being charged when the coolant moves through the first coolant passage corresponding to the first region can be used for heating the second battery pack when the coolant moves through the second coolant passage corresponding to the second region. Accordingly, the first battery pack and the second battery pack can be efficiently heated.

### <Technique 12>

The vehicle control device according to the technique 11, in which
when at least the first temperature of the first battery pack is lower than the first threshold temperature, the refrigerant is circulated such that the refrigerant is input from the first refrigerant input and output portion, passes through the refrigerant passage, and is output from the second refrigerant input and output portion, and the first coolant is circulated through the first coolant passage,
when the third temperature of the first battery pack is higher than the second threshold temperature, the first battery pack is charged, the first coolant and the second coolant are circulated through the first coolant passage and the second coolant passage in this order, and
when a fifth temperature of the second battery pack is higher than the third threshold temperature higher than the first threshold temperature, the second battery pack is charged.

Accordingly, the heat obtained from the first battery pack being charged when the coolant moves through the first coolant passage corresponding to the first region can be used for heating the second battery pack when the coolant moves through the second coolant passage corresponding to the second region. Accordingly, the first battery pack and the second battery pack can be efficiently heated.

### <Technique 13>

The vehicle control device according to the technique 11 or 12, in which
when at least the first temperature of the first battery pack is lower than the first threshold temperature, the refrigerant is circulated such that the refrigerant is input from the first refrigerant input and output portion, passes through the refrigerant passage, and is output from the second refrigerant input and output portion, and the first coolant is circulated through the first coolant passage, and
when the third temperature of the first battery pack is higher than the second threshold temperature, the first battery pack is charged, the first coolant and the second coolant are circulated through the first coolant passage and the second coolant passage in this order, the refrigerant is circulated such that the refrigerant is input from the second refrigerant input and output portion, passes through the refrigerant passage, and is output from the first refrigerant input and output portion, and a fourth temperature of the refrigerant entering the second refrigerant input and output portion is higher than the fifth temperature of the second battery pack.

Accordingly, the second battery pack corresponding to the second region can be efficiently heated by the high-temperature refrigerant.

### <Technique 14>

The vehicle control device according to the technique 11 or 12, in which
when at least the first temperature of the first battery pack is lower than the first threshold temperature, the refrigerant is circulated such that the refrigerant is input from the first refrigerant input and output portion, passes through the refrigerant passage, and is output from the second refrigerant input and output portion, and the first coolant is circulated through the first coolant passage,
when the third temperature of the first battery pack is higher than the second threshold temperature, the first battery pack is charged, the first coolant and the second coolant are circulated through the first coolant passage and the second coolant passage in this order, and the refrigerant is circulated such that the refrigerant is input from the second refrigerant input and output portion, passes through the refrigerant passage, and is output from the first refrigerant input and output portion, and
when the fifth temperature of the second battery pack is higher than the third threshold temperature higher than the first threshold temperature, the second battery pack is charged.

Accordingly, the second battery pack corresponding to the second region can be efficiently heated to a temperature appropriate for charging by the high-temperature refrigerant.

### <Technique 15>

The vehicle control device according to the technique 12 or 14, in which
when a sixth temperature of the first battery pack is higher than a fourth threshold temperature higher than the second threshold temperature and/or when a seventh temperature of the second battery pack is higher than a fifth threshold temperature higher than the third threshold temperature,
the refrigerant is circulated such that the refrigerant is input from one of the first refrigerant input and output portion and the second refrigerant input and output portion, passes through the refrigerant passage, and is output from the other of the first refrigerant input and output portion and the second refrigerant input and output portion, an eighth temperature of the refrigerant entering the one of the first refrigerant input and output portion and the second refrigerant input and output portion is lower than the sixth temperature of the first battery pack and/or the seventh temperature of the second battery pack.

Accordingly, the heat exchange plate can substantially uniformly cool the first battery pack and the second battery pack.

### <Technique 16>

The vehicle control device according to the technique 15, in which
when the sixth temperature of the first battery pack is higher than the fourth threshold temperature and/or when the seventh temperature of the second battery pack is higher than the fifth threshold temperature,
the refrigerant is circulated such that the refrigerant is input from the one of the first refrigerant input and output portion and the second refrigerant input and output portion, passes through the refrigerant passage, and is output from the other of the first refrigerant input and output portion and the second refrigerant input and output portion, and the eighth temperature of the refrigerant entering the one of the first refrigerant input and output portion and the second refrigerant input and output portion is lower than a ninth temperature of the first coolant.

Accordingly, the heat exchange plate can substantially uniformly cool the first battery pack and the second battery pack.

### <Technique 17>

The vehicle control device according to the technique 15, in which
when the sixth temperature of the first battery pack is higher than the fourth threshold temperature and/or when the seventh temperature of the second battery pack is higher than the fifth threshold temperature,
the refrigerant is circulated such that the refrigerant is input from the one of the first refrigerant input and output portion and the second refrigerant input and output portion, passes through the refrigerant passage, and is output from the other of the first refrigerant input and output portion and the second refrigerant input and output portion, and the first coolant and the second coolant are circulated through the first coolant passage and the second coolant passage in this order or through the second coolant passage and the first coolant passage in this order.

Accordingly, the heat exchange plate can substantially uniformly cool the first battery pack and the second battery pack.

### <Technique 18>

The vehicle control device according to the technique 15, in which
when the sixth temperature of the first battery pack is higher than the fourth threshold temperature and/or when the seventh temperature of the second battery pack is higher than the fifth threshold temperature,
the refrigerant is circulated such that the refrigerant is input from the one of the first refrigerant input and output portion and the second refrigerant input and output portion, passes through the refrigerant passage, and is output from the other of the first refrigerant input and output portion and the second refrigerant input and output portion, the first coolant is circulated through the first coolant passage, and the second coolant is circulated through the second coolant passage.

Accordingly, the heat exchange plate can substantially uniformly cool the first battery pack and the second battery pack.

### <Technique 19>

The vehicle control device according to any one of the techniques 11 to 18, in which
the vehicle includes at least a pump (41) and a heater (42), and includes a coolant circuit capable of causing the first coolant and/or the second coolant to circulate, and
the first coolant passage is connected to the coolant circuit.

Accordingly, the first coolant and/or the second coolant can be heated by the heater.

### <Technique 20>

The vehicle control device according to any one of the techniques 11 to 19, in which
the vehicle includes at least a compressor (for example, the compressor 31), and includes a refrigerant circuit capable of causing the refrigerant to circulate, and
the first refrigerant input and output portion (422) and the second refrigerant input and output portion (423) are connected to the refrigerant circuit.

Accordingly, the first battery pack and the second battery pack can be substantially uniformly heated to a temperature appropriate for charging, and the first battery pack and the second battery pack which are being charged can be substantially uniformly cooled.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

### INDUSTRIAL APPLICABILITY

The technique of the present disclosure is useful for adjusting a temperature of a secondary battery mounted on a vehicle.

### CROSS-REFERENCE TO RELATED APPLICATIONS

This application is based on and claims priority under 35 USC 119 from Japanese Patent Applications No. 2024-052246 filed on Mar. 27, 2024, No. 2024-052247 filed on Mar. 27, 2024, No. 2024-131186 filed on Aug. 7, 2024, and No. 2024-131187 filed on Aug. 7, 2024, the contents of which are incorporated herein by reference.

What is claimed is:

1. A vehicle control method executable in a vehicle, wherein
the vehicle includes
a vehicle body,
a first wheel and a second wheel coupled to the vehicle body,
a first battery pack disposed along a first surface in the vehicle body,
a second battery pack disposed along a second surface in the vehicle body,
a first heat exchange plate disposed along the first surface in the vehicle body,
a second heat exchange plate disposed along the second surface in the vehicle body, and
an electric motor that drives at least the first wheel using electric power supplied from the first battery pack and/or the second battery pack,
the vehicle is movable by the first wheel and the second wheel in a predetermined direction,
the first heat exchange plate includes
a third surface disposed along the first surface and capable of exchanging heat with the first battery pack,
a fourth surface disposed along the first surface and opposite to the third surface,
a first refrigerant layer in which a refrigerant circulates between the third surface and the fourth surface, and
a first coolant layer in which a coolant circulates between the third surface and the fourth surface,
the second heat exchange plate includes
a fifth surface disposed along the second surface and capable of exchanging heat with the second battery pack,
a sixth surface disposed along the second surface and opposite to the fifth surface,
a second refrigerant layer in which the refrigerant circulates between the fifth surface and the sixth surface, and
a second coolant layer in which the coolant circulates between the fifth surface and the sixth surface, and
the vehicle control method comprises:
in a case that a first temperature of the first battery pack and the second battery pack is lower than a first threshold temperature, causing the refrigerant to circulate through the first refrigerant layer of the first heat exchange plate at a first flow rate, and causing the refrigerant to circulate through the second refrigerant layer of the second heat exchange plate at a second flow rate lower than the first flow rate, a second temperature of the refrigerant entering the first refrigerant layer being higher than the first temperature of the first battery pack; and
in a case that a third temperature of the first battery pack is higher than a second threshold temperature higher than the first threshold temperature, charging the first battery pack and causing the coolant to circulate through the first coolant layer and the second coolant layer in this order.

2. The vehicle control method according to claim 1, further comprising:
in a case that the first temperature of the first battery pack and the second battery pack is lower than the first threshold temperature, causing the refrigerant to circulate through the first refrigerant layer of the first heat exchange plate at the first flow rate, and causing the coolant to circulate through the first coolant layer of the first heat exchange plate.

3. The vehicle control method according to claim 1, further comprising:
in a case that the third temperature of the first battery pack is higher than the second threshold temperature, charging the first battery pack; and
in a case that a fourth temperature of the first battery pack is higher than a third threshold temperature higher than the second threshold temperature, causing the refrigerant to circulate through the first refrigerant layer of the first heat exchange plate, a fifth temperature of the refrigerant entering the first refrigerant layer being lower than the fourth temperature of the first battery pack.

4. The vehicle control method according to claim 1, further comprising:
in a case that the third temperature of the first battery pack is higher than the second threshold temperature, charging the first battery pack, causing the coolant to circulate through the first coolant layer and the second coolant layer in this order, causing the refrigerant to circulate through the first refrigerant layer of the first heat exchange plate at a third flow rate, and causing the refrigerant to circulate through the second refrigerant layer of the second heat exchange plate at a fourth flow rate higher than the third flow rate, a sixth temperature of the refrigerant entering the second refrigerant layer being higher than a seventh temperature of the second battery pack.

5. The vehicle control method according to claim 4, further comprising:
in a case that the third temperature of the first battery pack is higher than the second threshold temperature, charging the first battery pack, causing the coolant to circulate through the first coolant layer and the second coolant layer in this order, and causing the refrigerant to circulate through the second refrigerant layer of the second heat exchange plate at the fourth flow rate; and
in a case that the seventh temperature of the second battery pack is higher than a fourth threshold temperature higher than the first threshold temperature, charging the second battery pack.

6. The vehicle control method according to claim 5, further comprising:
in a case that the seventh temperature of the second battery pack is higher than the fourth threshold temperature, charging the second battery pack; and
in a case that an eighth temperature of the second battery pack is higher than a fifth threshold temperature higher than the fourth threshold temperature, causing the refrigerant to circulate through the second refrigerant layer of the second heat exchange plate, a ninth temperature of the refrigerant entering the second refrigerant layer being lower than the eighth temperature of the second battery pack.

7. The vehicle control method according to claim 1, wherein
the first heat exchange plate includes
a first refrigerant input portion that allows the refrigerant to enter the first refrigerant layer,
a first refrigerant output portion that allows the refrigerant to exit from the first refrigerant layer,
a first coolant input portion that allows the coolant to enter the first coolant layer, and
a first coolant output portion that allows the coolant to exit from the first coolant layer,
the second heat exchange plate includes
a second refrigerant input portion that allows the refrigerant to enter the second refrigerant layer,
a second refrigerant output portion that allows the refrigerant to exit from the second refrigerant layer,
a second coolant input portion that allows the coolant to enter the second coolant layer, and
a second coolant output portion that allows the coolant to exit from the second coolant layer, and
a coolant circuit is formed in which in a case that the third temperature of the first battery pack is higher than the second threshold temperature, the coolant enters the first coolant input portion, exits from the first coolant output portion through the first coolant layer, enters the second coolant input portion, and exits from the second coolant output portion through the second coolant layer.

8. The vehicle control method according to claim 7, wherein
a heater capable of heating the coolant entering the second coolant input portion is further provided.

9. The vehicle control method according to claim 1, wherein
the first heat exchange plate is disposed along the predetermined direction, and
the second heat exchange plate is disposed along the predetermined direction.

10. The vehicle control method according to claim 1, wherein
the first heat exchange plate is disposed along a direction orthogonal to the predetermined direction,
the second heat exchange plate is disposed along the direction orthogonal to the predetermined direction, and
the orthogonal direction is a horizontal direction.

11. A vehicle control device to be mounted in a vehicle, wherein
the vehicle includes
a vehicle body,
a first wheel and a second wheel coupled to the vehicle body,
a first battery pack disposed along a first surface in the vehicle body,
a second battery pack disposed along a second surface in the vehicle body,
a first heat exchange plate disposed along the first surface in the vehicle body,
a second heat exchange plate disposed along the second surface in the vehicle body, and
an electric motor that drives at least the first wheel using electric power supplied from the first battery pack and/or the second battery pack,
the vehicle is movable by the first wheel and the second wheel in a predetermined direction,
the first heat exchange plate includes
a third surface disposed along the first surface and capable of exchanging heat with the first battery pack,
a fourth surface disposed along the first surface and opposite to the third surface,
a first refrigerant layer in which a refrigerant circulates between the third surface and the fourth surface, and
a first coolant layer in which a coolant circulates between the third surface and the fourth surface,
the second heat exchange plate includes
a fifth surface disposed along the second surface and capable of exchanging heat with the second battery pack,
a sixth surface disposed along the second surface and opposite to the fifth surface,
a second refrigerant layer in which the refrigerant circulates between the fifth surface and the sixth surface, and
a second coolant layer in which the coolant circulates between the fifth surface and the sixth surface,
in a case that a first temperature of the first battery pack and the second battery pack is lower than a first threshold temperature, the refrigerant is circulated through the first refrigerant layer of the first heat exchange plate at a first flow rate, and is circulated through the second refrigerant layer of the second heat exchange plate at a second flow rate lower than the first flow rate, and a second temperature of the refrigerant entering the first refrigerant layer is higher than the first temperature of the first battery pack, and
in a case that a third temperature of the first battery pack is higher than a second threshold temperature higher than the first threshold temperature, the first battery pack is charged, and the coolant is circulated through the first coolant layer and the second coolant layer in this order.

12. The vehicle control device according to claim 11, wherein
in a case that the first temperature of the first battery pack and the second battery pack is lower than the first threshold temperature, the refrigerant is circulated through the first refrigerant layer of the first heat exchange plate at the first flow rate, and the coolant is circulated through the first coolant layer of the first heat exchange plate.

13. The vehicle control device according to claim 11, wherein
in a case that the third temperature of the first battery pack is higher than the second threshold temperature, the first battery pack is charged, and
in a case that a fourth temperature of the first battery pack is higher than a third threshold temperature higher than the second threshold temperature, the refrigerant is circulated through the first refrigerant layer of the first heat exchange plate, and a fifth temperature of the refrigerant entering the first refrigerant layer is lower than the fourth temperature of the first battery pack.

14. The vehicle control device according to claim 11, wherein
in a case that the third temperature of the first battery pack is higher than the second threshold temperature, the first battery pack is charged, the coolant is circulated through the first coolant layer and the second coolant layer in this order, the refrigerant is circulated through the first refrigerant layer of the first heat exchange plate at a third flow rate, and is circulated through the second refrigerant layer of the second heat exchange plate at a fourth flow rate higher than the third flow rate, and a sixth temperature of the refrigerant entering the second refrigerant layer is higher than a seventh temperature of the second battery pack.

15. The vehicle control device according to claim 14, wherein
in a case that the third temperature of the first battery pack is higher than the second threshold temperature, the first battery pack is charged, the coolant is circulated through the first coolant layer and the second coolant layer in this order, and the refrigerant is circulated through the second refrigerant layer of the second heat exchange plate at the fourth flow rate, and
in a case that the seventh temperature of the second battery pack is higher than a fourth threshold temperature higher than the first threshold temperature, the second battery pack is charged.

16. The vehicle control device according to claim 15, wherein
in a case that the seventh temperature of the second battery pack is higher than the fourth threshold temperature, the second battery pack is charged, and
in a case that an eighth temperature of the second battery pack is higher than a fifth threshold temperature higher than the fourth threshold temperature, the refrigerant is circulated through the second refrigerant layer of the second heat exchange plate, and a ninth temperature of the refrigerant entering the second refrigerant layer is lower than the eighth temperature of the second battery pack.

17. The vehicle control device according to claim 11, wherein
the first heat exchange plate includes
a first refrigerant input portion that allows the refrigerant to enter the first refrigerant layer,
a first refrigerant output portion that allows the refrigerant to exit from the first refrigerant layer,
a first coolant input portion that allows the coolant to enter the first coolant layer, and
a first coolant output portion that allows the coolant to exit from the first coolant layer,
the second heat exchange plate includes
a second refrigerant input portion that allows the refrigerant to enter the second refrigerant layer,
a second refrigerant output portion that allows the refrigerant to exit from the second refrigerant layer,
a second coolant input portion that allows the coolant to enter the second coolant layer, and
a second coolant output portion that allows the coolant to exit from the second coolant layer, and
a coolant circuit is formed in which in a case that the third temperature of the first battery pack is higher than the second threshold temperature, the coolant enters the first coolant input portion, exits from the first coolant output portion through the first coolant layer, enters the second coolant input portion, and exits from the second coolant output portion through the second coolant layer.

18. The vehicle control device according to claim 17, wherein
a heater capable of heating the coolant entering the second coolant input portion is further provided.

19. The vehicle control device according to claim 11, wherein
the first heat exchange plate is disposed along the predetermined direction, and
the second heat exchange plate is disposed along the predetermined direction.

20. The vehicle control device according to claim 11, wherein
the first heat exchange plate is disposed along a direction orthogonal to the predetermined direction,
the second heat exchange plate is disposed along the direction orthogonal to the predetermined direction, and
the orthogonal direction is a horizontal direction.
